(19) United States
(12) Patent Application Publication
(10) Pub. No.: US 2025/0210628 A1
(43) Pub. Date: Jun. 26, 2025

(54) Coated Anode Composition

(71) Applicant: Anteo Energy Technology Pty Ltd., Eight Mile Plains (AU)

(72) Inventors: Manuel Christoph Wieser, Rochedale South (AU); Periyapperuma Achchige Mary Kalani Erangi, Mount Gravatt East (AU); Kai-Anders Hansen, Runcorn (AU); Khadija Alsabawi, Redland Bay (AU)

(21) Appl. No.: 18/844,569

(22) PCT Filed: Mar. 7, 2023
(86) PCT No.: PCT/AU2023/050154

§ 371 Date: Sep. 6, 2024

(30) Foreign Application Priority Data
Mar. 7, 2022 (AU) 2022900552

(51) Int. Cl. H01M 4/36; C01B 33/02; H01M 4/02; H01M 4/38; H01M 4/587

(52) U.S. Cl. CPC H01M 4/366; C01B 33/02; H01M 4/386; H01M 4/587; C01P 2004/61; C01P 2004/62; C01P 2004/80; C01P 2006/12; C01P 2006/40; C01P 2006/80; H01M 2004/021; H01M 2004/027

(57) ABSTRACT

The present disclosure generally relates to coated micro silicon active material particles and/or a coated anode an anode composition. The present disclosure also relates to an anode for a lithium-ion battery, and anode compositions thereof. The present disclosure also relates to a method of incorporating the anode composition into an electrochemical cell.

### CROSS-REFERENCE TO RELATED APPLICATIONS

This application is the United States national phase of International Patent Application No. PCT/AU2023/050154 filed Mar. 7, 2023, and claims priority to Australian Patent Application No. 2022900552 filed Mar. 7, 2022, the disclosures of which are hereby incorporated by reference in their entireties.

### BACKGROUND OF THE INVENTION

### Field of the Invention

The present disclosure generally relates to coated micro silicon active material particles and/or a coated anode comprising an anode composition. The present disclosure also relates to an anode for a lithium-ion battery, and anode compositions thereof. The present disclosure also relates to a method of incorporating the anode composition into an electrochemical cell.

### Description of Related Art

Conventional lithium-ion (Li-ion) batteries typically employ a graphite-dominant anode as an intercalation material for lithium. Silicon-dominant anodes, however, offer improvements compared to graphite-dominant Li-ion batteries. Silicon (based on Li_{3.75}Si) exhibits both higher gravimetric (3579 mAh/g vs. 372 mAh/g for graphite) and volumetric capacities (˜2194 mAh/cm³ vs. ˜750 mAh/cm³ for graphite in a fully lithiated state). In addition, silicon-based anodes have a low lithiation/delithiation voltage plateau at about 0.3-0.4V vs. Li/Li⁺, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon active materials and regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Because of its high specific capacity, abundance and low cost, silicon is a promising active material for Li-ion anodes. However its large volume change during lithiation and delithiation (>280% volume change for the Li_{3.75}Si₁ phase) creates mechanical degradation of the electrode and an unstable SEI which leads to electrode swelling and poor cell cycle life.

Therefore, there is a need to provide new and alternative anode compositions for lithium ion batteries, particularly those comprising a majority silicon active material, that can control the expansion effects of silicon and significantly extend the stability and/or cycle life of the anode.

### SUMMARY OF THE INVENTION

The present disclosure provides coated micro silicon active material particles and/or a coated anode comprising the anode composition. The anode composition may comprise micro silicon active material particles or coated micro silicon active material particles, wherein the silicon content is at least 60 wt. % based on the total weight of the anode composition. The present disclosure also provides a method of incorporating an anode comprising the anode composition into a electrochemical cell and an electrochemical cell so formed, whereby the anode paired with the method of integration into the electrochemical cell can extend the stability and/or cycle life of the anode. The anode composition and/or formed anode may be coated.

In one aspect there is a provided an anode composition comprising micro silicon active material particles, wherein the micro silicon active material particles have one or more of the following (i) a measured BET surface area between about 0.1 m²/g and about 10 m²/g. (ii) a D₅₀ particle size between about 0.1 μm and about 10 μm, and (iii) a ratio of D₅₀:BET surface area between about 0.1 and about 10, wherein the amount of the micro silicon active material particles present in the anode composition is between about 60 wt. % and about 95 wt. % based on the total weight % of the anode composition, and wherein the anode composition comprises a coating. In some embodiments, the coating may be a coating of the micro silicon active material particles. The coating may be selected from the group comprising carbon, graphene, graphite, metal oxide, polymer, and combinations thereof, to form a coated micro silicon active material particle.

In some embodiments, the surface area of the coated micro silicon active material particle will decrease compared to the surface area of the uncoated micro silicon active material particle. It will be appreciated that in some examples, the surface area can decrease if the micro silicon active material particle had a roughened surface wherein the coating may in fact fill these defects. In other embodiments, the surface area of the coated micro silicon active material particle will increase compared to the surface area of the uncoated micro silicon active material particle. In some embodiments, the measured BET surface area of the coated micro silicon active material particles may be between about 1 m²/g and about 100 m²/g. In some embodiments, the amount of the micro silicon active material particles or the coated micro silicon active material particles present in the anode composition may be between about 70 wt. % and about 95 wt. % based on the total weight % of the anode composition. In some embodiments, the purity of the micro silicon active material particles (without oxygen) may be at least 95 wt. %, preferably 98 wt. %. In some embodiments, the thickness of the coating may be between about 0.1 nm and about 200 nm.

In some embodiments, the anode composition may further comprise one or more binders. The amount of binder present in the anode composition may be between about 2.5 wt. % to about 15 wt. % based on the total weight of the anode composition.

In some embodiments, the anode composition may further comprise one or more conductive materials. The amount of conductive material present in the anode composition may be between about 2.5 wt. % to about 40 wt. % based on the total weight of the anode composition.

In some embodiments, the micro silicon active material particles or the coated active material particles and/or the anode composition may be prelithiated. The prelithiation level of the micro silicon active material particles or the coated active material particles and/or the anode composition may be between about 1% and about 30% silicon lithiation.

In another aspect there is provided an electrochemical cell comprising: an anode; a cathode; an electrolyte; and a separator, wherein the anode comprises the anode composition defined in any one or more embodiments or examples described herein, wherein the lithium uptake capacity of the anode is greater than the lithium release capacity of the cathode. In some embodiments, the capacity of the lithium uptake capacity of the anode may not be fully utilized during charging of the lithium ion battery. In an example, the anode may be only partially lithiated in the fully charged state. In some embodiments, the degree of silicon lithiation may be limited to about 20% to about 80% of the theoretical maximum. In some embodiments, a capacity ratio (N/P ratio) of the anode and the cathode may be between about 1.05 and about 7. In other embodiments, the lower cut-off voltage may be between about 2.0V and 3.5V.

In some embodiments, the prelithiation level of the anode may be between about 1% and about 30% silicon lithiation. The cathode may comprise an active material selected from the group comprising lithium nickel cobalt manganese oxide (NCM), lithium iron phosphate (LFP), lithium nickel manganese spinel (LNMO), lithium nickel cobalt aluminium oxide (NCA), lithium manganese oxide (LMO), lithium cobalt oxide (LCO), and sulphur or a sulphur composite. The electrolyte may be selected from a non-aqueous electrolyte solution comprising one or more lithium salts.

In some embodiments, the electrochemical cell may be an energy storage device. The energy storage device may be a battery, preferably a secondary battery. For example, the battery may be a lithium-ion battery.

In another aspect there is provided a method for improving cycling stability of a lithium-ion battery having an anode and a cathode, at least one electrolyte, and a separator, wherein the anode composition is defined by any one or more embodiments or examples described herein. In some embodiments, the anode within the battery delivers a specific capacity of at least about 450 mAh/g, 500 mAh/g, 600 mAh/g, 800 mAh/g, 1000 mAh/g, 1200 mAh/g, or 1500 mAh/g and retains at least about 80% of its initial capacity after 100, 200, 400, 600, 800, 1000 or 1500 cycles of the battery.

In another aspect there is provided a use of an anode composition in an electrochemical cell, wherein the anode composition is at least partially applied to a current collector material, and wherein the anode composition is as defined by any one or more embodiments or examples described herein.

In another aspect there is provided a process for preparing an anode for an electrochemical cell, comprising the steps of: (i) preparing an anode slurry comprising micro silicon active material particles or coated micro silicon active material particles, optionally one or more further active materials, optionally one or more binders, optionally one or more conductive materials, optionally one or more additives, and a solvent system; and (ii) casting a layer of the anode slurry onto a current collector material to provide an anode composition layer on the current collector material, and (iii) optionally coating the anode composition, wherein the micro silicon active material particles have one or more of the following (a) a measured BET surface area between about 0.1 m²/g and about 10 m²/g. (b) a D₅₀ particle size between about 0.1 μm and about 10 μm, and (c) a ratio of D₅₀:BET surface area between about 0.1 and about 10.

In another aspect there is provided an anode prepared as defined by the process in any one or more embodiments or examples described herein.

In another aspect there is provided process for assembling an electrochemical cell, whereby the process comprises the following steps: preparing an anode as defined by the process in any one or more embodiments or examples as described herein, wherein the anode comprises an anode composition as defined in any one or more embodiments or examples as described herein; and assembling the anode into an electrochemical cell.

In any of the above aspects and embodiments, the micro silicon active material particles and/or the anode comprising the anode composition comprise a coating.

### BRIEF DESCRIPTION OF THE DRAWINGS

Preferred embodiments of the present disclosure will be further described and illustrated, by way of example only, with reference to the accompanying drawings in which:

FIG. 1a is a graph showing specific coating capacity of 70 wt % mSi limited capacity (with Al₂O₃ coating vs uncoated mSi) full cells (anode) at C/2.

FIG. 1b is a graph showing discharge capacity retention of 70 wt % mSi limited capacity (with Al₂O₃ coating vs uncoated mSi) full cells (anode) at C/2.

FIG. 2a is a graph showing specific coating capacity of 70 wt % mSi limited capacity (with PR coating vs uncoated mSi) full cells (anode) at C/2.

FIG. 2b is a graph showing discharge capacity retention of 70 wt % mSi limited capacity (with PR coating vs uncoated mSi) full cells (anode) at C/2.

FIG. 3a is a graph showing specific coating capacity of 70 wt % mSi limited capacity (PVP-SPD coating vs uncoated) full cells (anode) at C/2.

FIG. 3b is a graph showing discharge capacity retention of 70 wt % mSi limited capacity (PVP-SPD coating vs uncoated) full cells (anode) at C/2.

FIG. 4a is a graph showing specific coating capacity of 70 wt % mSi limited capacity (with PAN coating vs uncoated mSi) full cells (anode) at C/2.

FIG. 4b is a graph showing discharge capacity retention of 70 wt % mSi limited capacity (with PAN coating vs uncoated mSi) full cells (anode) at C/2.

FIG. 5a is a graph showing specific coating capacity (anode) at C/2 of prelithiated 70 wt % mSi anodes (at 0 and 10% prelithiation).

FIG. 5b is a graph showing discharge capacity retention of prelithiated 70 wt % mSi anodes (at 0 and 10% prelithiation) full cells at rate of C/2.

### DESCRIPTION OF THE INVENTION

The present disclosure describes the following various non-limiting examples, which relate to investigations undertaken to identify alternative and improved anodes comprising a majority micro silicon anode composition for lithium ion batteries, to any methods of incorporating the anodes into electrochemical cells, to electrochemical cells so formed and to use thereof.

### General Definitions and Terms

In the following description, reference is made to the accompanying drawings which form a part hereof, and which is shown, by way of illustration, several embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, and processes, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first.” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”. “consist of” and “consists of”, respectively, in every instance.

Herein the term “about” encompasses a 10% tolerance in any value or values connected to the term.

Herein the term “weight %” may be abbreviated to as “wt. %”.

### Specific Terms

Herein the term “lithiation” encompasses lithiation of either the anode or the cathode and is intended to denote the insertion or alloying of Li⁺ with the active material.

Herein the term “de-lithiation” encompasses lithiation of either the anode or the cathode and is intended to denote the extraction or dealloying of Li⁺ with the active material.

The term “charge” can be used in the context of a full cell and a half cell. In the full cell, the term “charge” encompasses the involuntary process of forcing Lit to migrate from the cathode into the anode upon assembly of a full cell (initial pairing of anode and cathode) and denotes a rise in the cell voltage. In the half cell, the term “charge” encompasses the involuntary process of Lit extraction from the working electrode and deposition on the reference electrode (lithium metal foil) and denotes a rise in cell voltage.

The term “discharge” can be used in the context of a full cell and a half cell. In the full cell, the term “discharge” encompasses the voluntary process of extracting Lit ions from the anode and their migration from the anode to the cathode upon assembly and denotes a decrease in the cell voltage. In the half cell, the term “discharge” encompasses the voluntary process of Lit dissolution from the reference electrode (lithium metal foil) and the insertion of Lit into the working electrode and denotes a decrease in the cell voltage.

As used herein, the term “half cell” describes a reference test system used for research and development purposes consisting of a working electrode (electrode of interest) and reference electrode (e.g. lithium metal foil).

As used herein, the term “full cell” describes a conventional electrochemical cell system pairing a commercially relevant anode (graphite, silicon, LTO) with a commercially relevant cathode (LFP, LCO, NCM, NCA, LMO).

The term “prelithiation” describes the insertion of Lit into the anode or the anode active material before pairing with a cathode electrode in a full cell format.

The term “N/P ratio” or “negative to positive ratio” refers to the mass balance between the anode (negative electrode) and cathode (positive electrode). The mass balance is determined by the available area capacity per cm² of the respective electrodes.

The term “area capacity” refers to the available capacity of an electrode (anode or cathode) per area. Determined by type and wt. % of active material in the coating as well as the amount of coating loading applied to the current collector substrate in mg/cm² (or g/m²). The higher the loading in mg/cm² the higher the area capacity per cm².

### Coated Micro Silicon Particles

The present disclosure relates, at least in part, to coated micro silicon active material particles and/or a coated anode comprising the anode composition described herein. It is believed that the coatings applied to the micro silicon active material particles, as described herein, can improve cycling stability and reduce electrolyte decomposition due to electrochemical protection of the anode surface. It will be appreciated that the coating may provide the micro silicon active particles and/or anode with one or more of a number of properties including, for example, structural strength, lower surface area, reduced pulverization, electron conductivity, Li-ion conductivity, passivation and/or insulation, and ultimately improve silicon anode capacity retention.

In some embodiments the coating may protect the surface of the micro silicon particle from ongoing contact with the electrolyte and can therefore assist in reducing or eliminating the continuous reformation of the SEI layer with every charge and discharge cycle, and the associated loss of lithium. To achieve this outcome the coating should be thick enough to form an effective barrier; flexible enough to withstand the expansion behaviour of the micro silicon active material; but thin enough to avoid or minimize impeding lithium ion or electron transfer from the electrolyte to the active material and vice versa. The coating is preferably electrochemically inert and so forms a passivating layer on the micro silicon particle active material surface.

In another embodiment the coating may be highly conductive. A highly conductive coating may further decrease interface resistance between micro silicon particles and between those particles and the current collector.

In some embodiments, the coating may tune the chemistry of an active material to provide greater affinity with binder chemistries. For example, if the binder is more hydrophobic, a more hydrophobic active material surface would have greater affinity (and vice versa).

In some embodiment, the coating may reduce charge transfer resistance at the interphases and increase electronic conductivity of the micro silicon particles.

In yet another embodiment the coating may form a passivating layer. A coating that acts as a passivating layer may prevent oxidation of the micro silicon active material once integrated into water-based anode slurries thus preventing the formation of hydrogen gas during processing while keeping the maximum amount of the micro silicon active material electrochemically active.

The coating may have different morphologies. The resulting morphology of the coating may be subject to the coating method that is used for the purpose of applying the coating and/or the chemical nature of the precursor material or the coating material used. In one embodiment the coating may comprise loose aggregates or particulates, including nano or micron-sized fibers, flakes, fine particles and the like, placed on or embedded into the outer surface of the micro silicon particle. The particulates may have comprise a micro or nano-sized powder, fibres or flakes. In another embodiment the coating may comprise a discontinuous layer. In another embodiment the coating may comprise a continuous layer. In yet another embodiment the coating may comprise a conformal layer. In other embodiments the coating may present a pin-hole free of quasi pin-hole free coating.

The coating may be present in the anode layer from about 0.1 wt. % to about 20 wt. %, or from about 0.1 wt. % to about 15 wt. %, or from about 0.1 wt. % to about 10 wt. %. It will be understood that the coating wt. % will be minimized to the amount that gives the most beneficial performance to achieve the intended outcome.

In some embodiments, the coating may be selected from the group comprising carbon, graphene, graphite, metal oxide, polymer, and combinations thereof, to form a coated micro silicon active material particle or a coated anode composition.

In some embodiments or examples, the thickness of the coating may be between about 0.1 nm and about 200 nm, or between about 0.2 nm and about 150 nm, or between about 0.3 nm and about 100 nm, or between about 0.3 nm and about 75 nm, or between about 0.3 nm and about 50 nm, or between about 0.3 nm and about 25 nm, or between about 0.3 nm and about 0.20 nm, or between about 0.3 nm and about 10 nm. The thickness of the coating (in nm) may be less than about 200, 175, 150, 125, 100, 90, 80, 75, 70, 65, 60, 55, 50, 45, 40, 35, 30, 25, 20, 15, 10, 8, 6, 5, 4, 3, 2, 1, 0.8, 0.5, 0.2, or 0.1. The thickness of the coating (in nm) may be at least about 0.1, 0.2, 0.3, 0.4, 0.5, 0.6, 0.7, 0.8, 0.9, 1, 2, 3, 4, 5, 6, 7, 8, 9, 10, 12, 14, 16, 18, 20, 25, 30, 35, 40, 45, 50, 55, 60, 65, 70, 75, 80, 100, 150, or 200. The thickness of the coating (in nm) may be in a range provided by any two of these upper and/or lower amounts.

In some embodiments, the ratio of the coating thickness to uncoated silicon particle diameter (t/d as X: 1) may be between about 0.0001:1 to about 0.2:1, or between about 0.0001:1 to about 0.15:1, or between about 0.0001:1 to about 0.12:1, or between about 0.0001:1 to about 0.1:1, or between about 0.0001:1 to about 0.09:1, or between about 0.0001:1 to about 0.085:1. Viewed another way, in some embodiments, the ratio of the silicon particle diameter to coating thickness (d/t as 1:X) may be between about 1:100,000 to about 1:5, or between about 1:100,000 to about 1:8, or between about 1:100,000 to about 1:10, or between about 1:100,000 to about 1:12.

The silicon active material particles herein may be coated with a form of carbon. The carbon coating may comprise predominantly sp² hybridized carbon or predominantly sp³ hybridized carbon. The carbon coating may also comprise varying degrees of sp² and sp³ hybridization. Some embodiments of the coating may comprise a high level of sp² hybridization and a low level of sp³ hybridization or vice versa. In some embodiments the level of sp² hybridization with respect to the coating may be in between 1% to 100%. In another embodiment the level of sp³ hybridization may be in between 1% to 100%. A particular coating embodiment may comprise a level of 10%, 20%, 30%, 40%, 50%, 60%, 70%, 80, 90%, 99% or 100% sp² hybridization which may be combined with a level of sp³ hybridization of 1−% sp² hybridization*100. In other words whatever the level of sp² hybridization, in a mixed sp²/sp³ hybridization coating, the remainder of the coating is made up of the sp³ hybridization. Another coating embodiment may comprise a level of 10%, 20%, 30%, 40%, 50%, 60%, 70%, 80, 90% or 100% sp³ hybridization whereas the level of sp² hybridization is 1-% sp³ hybridization*100.

Carbon-coated silicon active material particles may be provided by coating the micro silicon active material particles, as described herein, with a carbon using one or more carbon precursors. As used herein, the term “carbon” may refer to an amorphous or a non-graphitizable carbon coating, a graphitic carbon coating, or graphene. A non-graphitizable material is a carbon material that remains substantially amorphous even when exposed to high temperatures. As discussed above, the carbon coatings may demonstrate a range of mixed sp²/sp³ hybridization. The carbon coatings may be applied using a range of techniques which are known in the art including, but not limited to, CVD, PVD, pyrolysis and the like.

In embodiments, the amorphous carbon coating may be a coating with a soft carbon or a hard carbon, as are known in the art. It will be appreciated that a wide range of precursor materials are commercially available to achieve such amorphous carbon coatings with carbon black, petroleum pitch, coal tar pitch, acetylene gas, decomposable polymers, preferably decomposable polymers with a low oxygen content, such as PVP (Polyvinylpyrrolidone). Polyacrylonitrile (PAN), polyaniline (PANi), polypyrrole (PPy), melanin resin, phenolic resin, polydopamine, resorcinol formaldehyde resin, citric acid and glucose merely being some non-limiting examples. Amorphous carbon layers may generally be obtained via pyrolytic processes, in which the micro silicon particle would be exposed to a decomposable gas such as acetylene which then deposits on the surface as a layer of carbon when heated to a sufficiently high temperature. Alternatively, they may be obtained by coating the micro silicon particles in a precursor material such as pitch or combustible polymers and pyrolyzing the pitch or polymer to form a carbon layer. Different carbon precursors can be selected to form different qualities of carbon layer. For example, aromatic compounds may form a quality coating which may have a higher degree of sp² hybridization. More linear organic compounds such as acetylene or certain polymers may form more amorphous structures with a higher degree of sp³ hybridization.

In some embodiments, graphene-coated micro silicon active material particles may be provided by coating the micro silicon active material particles, as described herein, with graphene. In some embodiments, the graphene may be selected from the group comprising graphene, graphene oxide or reduced graphene oxide and derivatives thereof. Graphite-coated micro silicon active material particles may be provided by coating the micro silicon active material particles, as described herein, with graphite. In some embodiments, the graphite may be selected from the group comprising graphite, nano graphite, graphite oxide and derivatives thereof.

Metal oxide-coated micro silicon particles may be provided by coating the micro silicon active material particles, as described herein, with a metal oxide. In some embodiments, the metal oxide may be selected from the group comprising aluminium oxide, aluminium oxide hydroxide (γ-AlO(OH)), aluminium hydroxide (Al(OH)₃), aluminium nitrate (Al(NO₃)₃) or other comparable aluminium containing species. In some embodiments the aluminium hydroxide or the aluminium nitrate may form a precursor for subsequent conversation to aluminium oxide hydroxide or aluminium oxide. In some embodiments the aluminium oxide may comprise alpha aluminium oxide. In another embodiment the metal oxide may comprise titanium or niobium based metal oxide. The metal oxide coating may comprise titanium oxide (TiO₂) or niobium oxide (Nb₂O₅). In yet another embodiment the metal oxide coating may comprise a magnesium based oxide. The magnesium based oxide may be magnesium oxide (MgO).

In embodiments, metal oxides, such as for example α-aluminium oxide and other aluminium species, may be applied to the micro silicon particles via either precipitation processes followed by calcination at higher temperatures of >400° C. or via processes such as atomic layer deposition (ALD). The precipitation process route typically involves dissolving the appropriate metal salt in water at an appropriate concentration and under controlled pH and manipulating the pH so that the metal salt uniformly precipitates on the surface of the micro silicon active material. Typically this involves raising the pH of the environment. The concentration of the metal salt in solution determines the final coating layer thickness. Excess components and metal salt may be gently washed and the micro silicon active material may be transferred into a furnace. The precipitate may be heated under air or an inert gas to a temperature of up 1200° C. which converts the metal salt precursor to the corresponding metal oxide.

Polymer-coated micro silicon active material particles may be provided by coating the micro silicon active material particles, as described herein, with a polymer. In some embodiments, the polymer may be selected from the group comprising starch, lignin, cellulose, polyacrylamide, polymethacrylamide, polyamic acid, polystyrene-4-sulfonate (PSS), 3,4-ethylenedioxythiophene/polystyrene-4-sulfonate (PEDOT:PSS), polydiallyldimethylammonium chloride PDDA, polydiallyldimethylammonium/polystyrene-4-sulfonate (PDDA:PSS), urea-pyrimidinone (UPy), urea-oligo-amidoamine (UOAA), dopamine methacrylamide, dopamine methacrylate, dopamine acrylate, dopamine, hydroxyethyl acrylate, hydroxypropyl acrylate, hydroxyethyl methacrylate, hydroxypropyl methacrylate, polyethylene glycol methyl ether methacrylate and polyethylene glycol methyl ether acrylate, natural polyisoprene, including cis-1,4-polyisoprene natural rubber and trans-1,4-polyisoprene gutta-percha, synthetic polyisoprene, polybutadiene, chloroprene rubber, polychloroprene, butyl rubber, including halogenated butyl rubbers, styrene-butadiene rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, thermoplastic elastomers, protein resilin, protein elastin, ethylene oxide-epichlorohydrin copolymer, polyurethane, urethane-urea copolymer, polyaniline, polypyrrole, polythiophene, polyfuran, bi-cyclic polymers, poly(ethylene oxide) (PEO), polypropylene oxide (PPO), poly(acrylonitrile) (PAN), poly(methyl methacrylate) (PMMA), poly(vinylidene fluoride) (PVdF), poly((bis-(methoxyethoxy) ethoxy)phosphazene), polyvinyl chloride, polydimethylsiloxane, poly(vinylidene fluoride)-hexafluoropropylene (PVDF-HFP), any derivatives thereof (e.g. sulfonated derivatives), phenolic resin, or any combination thereof.

In some embodiments, the coated micro silicon active material particles may be provided from precipitation, pyrolization of a precursor formulation coating or by chemical vapour deposition, physical vapour deposition, atomic layer deposition sputtering, or mechanical deposition.

In some embodiments or examples, the coating may be in the form of a single layer on the surface of the micro silicon active material particle. In another embodiment, the coating may be in the form of two or more layers, for example, a plurality of layers on the surface of the micro silicon active material particle. The coating may comprise between about 1 to 5 layers. The coating may comprise less than 5 layers, 4 layers, 3 layers, or less than 2 layers. The coating may comprise at least about 1 layer, 2 layers, 3 layers, 4 layers, or at least about 5 layers. The coating may comprise layers in a range provided by any lower and/or upper limit as previously described. It will be appreciated that each layer may be provided by a different coating. For example, the coated micro silicon active material particles may comprise a coating, wherein a coating layer comprises a graphene and a further coating layer comprises a metal oxide (e.g., aluminium oxide), applied in either order to the micro silicon.

In one embodiment, coated micro silicon active material particles may present any morphology, for example they may take the form of flakes, agglomerates, granules, powders, spheres, pulverized materials or the like, as well as combinations thereof. The coated micro silicon active material particles may have any desired shape including, but not limited to, cubic, rod like, plate-like, polyhedral, spherical or semi-spherical, quasi spherical, rounded or semi-rounded, angular, irregular, and so forth. In one embodiment, the coated micro silicon active material particles have an aspect ratio (i.e. the ratio of a length to a width, where the length and width are measured perpendicular to one another, and the length refers to the longest linearly measured dimension) of 1.0 to 10.0, 1.0 to 5.0, or 1.0 to 4.0. In one embodiment, the coated micro silicon active material particles may have an aspect ratio of about 1.0 to 4.0, for example about 1.0, 1.5, 2.0, 2.5, 3.0, 3.5 or 4.0.

In some embodiments, the particle size (in μm) of the coated micro silicon active material particles may be at least about 0.5, 1, 2, 3, 4, 5, 6, 7, 8, 9, 10, 15, 20, 25, 30, 35, 40, 45, or 50. In some embodiments, the particle size (in μm) of the coated micro silicon active material particles may be less than about 50, 45, 40, 35, 30, 25, 20, 15, 10, 9, 8, 7, 6, 5, 4, 3, 2, 1, or 0.5. Combinations of any two or more of these upper and/or lower particle sizes are also possible, for example the particle size (in μm) of the coated micro silicon active material particles may be between about 1 to about 50, about 2 to about 40, or about 3 to about 30. The particle size is taken to be the longest cross-sectional diameter across a coated micro silicon active material particle. For non-spherical coated micro silicon active material particles, the particle size is taken to be the distance corresponding to the longest cross-section dimension across the particle.

The coated micro silicon active material particles may have a particle size distribution, wherein 90% of the micro silicon active material particles (D₉₀) have a particle size of less than about 50, 45, 40, 35, 34, 32, 30, 28, 24, 20, 18, 16, 14, 12, 10, 8, 6, 5 or 4 μm, wherein 50% of the micro silicon active material particles (D₅₀) have a particle size (in μm) of less than about 10, 9, 87, 6, 5, 4, 3, 2, 1, 0.8, 0.6, 0.4, 0.2, 0.1, or wherein 10% of the micro silicon active material particles (D₁₀) have a particle size of less than about 4, 3, 2, or 1 μm. In some embodiments, the micro silicon active material particles have a (D₅₀) particle size (in μm) of at least about 0.1, 0.2, 0.3, 0.4, 0.5, 0.6, 0.7, 0.8, 0.9, 1, 2, 3, 4, 5, 6, 7, 8, 9 or 10. In some embodiments, the micro silicon active material particles have a (D₅₀) particle size (in μm) of less than about 10, 9, 8, 7, 6, 5, 4, 3.5, 3, 2.5, 2, 1, 0.9, 0.8, 0.7, 0.6, 0.5, 0.5, 0.4, 0.3, 0.2, or 0.1. Combinations of any two or more of these upper and/or lower particle sizes are also possible, for example the micro silicon active material particles have a (D₅₀) particle size (in μm) of between about 0.1 to about 10, about 0.1 to about 9, about 0.1 to about 8, about 0.1 to about 7, about 0.1 to about 6, about 0.1 to about 5, about 0.5 to about 10, about 0.5 to about 9, about 0.5 to about 8, about 0.5 to about 7, about 0.5 to about 6, about 0.5 to about 5, about 1 to about 10, about 1 to about 9, about 1 to about 8, about 1 to about 7, about 1 to about 6, or about 1 to about 5.

In some embodiments or examples, the coated micro silicon active material particles may have a BET surface area in a range of from about 0.1 m²/g to about 100 m²/g. The coated micro silicon active material particles may have a BET surface area (m²/g) of at least about 0.1, 0.5, 1, 2, 3, 4, 5, 6, 7, 8, 9, 10, 15, 20, 25, 30, 35, 40, 45, 50, 60, 70, 80, 90, or 100 m²/g. In other embodiments or examples, the coated micro silicon active material particles may have a surface area (m²/g) of less than about 100, 90, 80, 70, 60, 50, 45, 40, 35, 30, 25, 20, 10, 9, 8, 7, 6, 5, 4, 3, 2 1, 0.5, or 0.1 m²/g. Combinations of these surface area values to form various ranges are also possible.

In some embodiments or examples, the tap density of the coated micro silicon active material particles may be in a range of from about 0.5 g/cm³ to about 1.5 g/cm³. The tap density of the coated micro silicon active material particles may be at least about 0.5, 0.55, 0.6, 0.65, 0.7, 0.75, 0.8, 0.85, 0.9, 0.95, 1.0, 1.2, 1.3 or 1.5 g/cm³. In other embodiments or examples, the tap density of the coated micro silicon active material particles may be less than about 1.5, 1.4, 1.3, 1.2, 1.0, 0.95, 0.9, 0.85, 0.8, 0.75, 0.7, 0.65, 0.6, 0.55, or 0.5 g/cm³. Combinations of these density values to form various ranges are also possible, for example the coated micro silicon active material particles may have a tap density of between about 0.5 g/cm³ to about 1.2 g/cm³. The density can be measured by any standard method, for example in accordance with ASTM D7481-18.

Advantageously, the micro silicon active material particles of the present disclosure may be provided in a high purity. In an embodiment or example, the purity of micro silicon active material particles (without oxygen) may be in a range from (by wt. %) about 95 to about 99.9. The purity of micro silicon active material particles (without oxygen) may be at least (by wt. c) about 95, 96, 97, 98, 99, 99.5, or 99.9. The purity of the micro silicon active material particles (without oxygen) may be less than (by wt. %) about 99.9, 99.5, 99, 98, 97, 96, or 95. The purity of micro silicon active material particles (without oxygen) may be in a range provided by any lower and/or upper limit as previously described.

In an embodiment or example, the purity of micro silicon active material particles (with oxygen) may be in a range from (by wt. %) about 79 to about 99.5. The purity of micro silicon active material particles (with oxygen) may be at least (by wt. %) about 75, 80, 85, 90, 95, 96, 97, 98, 99 or 99.5. The purity of the micro silicon active material particles (with oxygen) may be less than (by wt. %) about 99.5, 99, 98, 97, 96, 95, 90, 85, 80, or 75. The purity of micro silicon active material particles (with oxygen) may be in a range provided by any lower and/or upper limit as previously described.

The combination of novel and inventive features of the coated micro silicon active material particles according to the present disclosure and its use in an anode composition for an anode in a lithium ion battery may also surprisingly lead to an improvement in the batteries cycle behaviour. It was unexpectedly shown that the lithium-ion batteries, as described herein, have a small irreversible capacity loss in the first charge cycle and a stable electrochemical behaviour with minimal fading in the subsequent cycles. Therefore, with the use of the coated micro silicon active material particles, as described herein, a lower initial capacity loss and also a low continuous loss of capacity of the lithium-ion batteries can be achieved. Overall, the lithium-ion batteries as described herein provide very good stability and cycle life. Accordingly, a high number of cycles can be achieved with minimal fatigue, for example, as a consequence of mechanical destruction of the anode coating layer, anode material or SEI formation.

### Anode Composition

The present disclosure is directed to providing improvements in anodes for lithium ion batteries. The present disclosure covers various research and development directed to identifying and better understanding the failure mechanisms of anodes comprising majority silicon anode compositions and subsequently optimising their formulations such that the degradation (e.g., cracking and delamination), silicon particle fracturing and instability of the solid electrolyte interphase can be controlled, reduced or in some manner ameliorated to improve stability and cyclability of the lithium ion battery.

It has been surprisingly found that the majority silicon anode composition, at least according to some examples as described herein, can demonstrate significant stability and/or cycle life of an anode. It has further been surprisingly found that the majority silicon anode composition paired with the method of integration into the electrochemical cell can control the formation of SEI and the expansion and degradation of silicon, and therefore significantly extend the stability and/or cycle life of the anode.

It has also been found that the majority silicon anode composition for an electrochemical cell (e.g. battery), at least according to some examples as described herein, may provide one or more further advantages such as:
(a) long term cycling stability of lithium ion (Li-ion) cells;
(b) controlled expansion and contraction of silicon during charge and discharge cycles of the Li-ion cell, which minimizes silicon particle cracking, pulverization, and SEI growth;
(c) reduced cell capacity fading during cycle life due to controlled silicon expansion/contraction and silicon anode voltage window; and/or
(d) high rate capability.

The anode composition as described herein may comprise micro silicon active material particles, wherein the micro silicon active material particles have one or more of the following (i) a measured BET surface area between about 0.1 m²/g and about 10 m²/g, (ii) a D₅₀ particle size between about 0.1 μm and about 10 μm, and (iii) a ratio of D₅₀:BET surface area between about 0.1 and 10, and wherein the amount of silicon present in the anode composition is between about 60 wt. % and about 95 wt. % based on the total weight % of the anode composition.

In some embodiments, the anode composition as described herein may comprise micro silicon active material particles, wherein the micro silicon active material particles have (i) a measured BET surface area between about 0.1 m²/g and about 10 m²/g and (ii) a D₅₀ particle size between about 0.1 μm and about 10 μm, or (iii) a ratio of D₅₀:BET surface area between about 0.1 and 10, and wherein the amount of silicon present in the anode composition is between about 60 wt. % and about 95 wt. % based on the total weight % of the anode composition.

The anode composition as described herein may comprise or consist of the micro silicon active material particles, as described herein, optionally one or more further active materials, optionally one or more binders, optionally one or more conductive materials, and optionally one or more additives. In one example, the anode composition as described herein may comprise or consist of micro silicon active material particles, wherein the micro silicon active material particles have one or more of the following (i) a measured BET surface area between about 0.1 m²/g and about 10 m²/g. (ii) a D₅₀ particle size between about 0.1 μm and about 10 μm, and (iii) a ratio of D₅₀:BET surface area between about 0.1 and 10, wherein the micro silicon active material particles are coated, and wherein the amount of the coated micro silicon active material particles present in the anode composition is between about 60 wt. % and about 95 wt. % based on the total weight % of the anode composition; optionally one or more further active materials, optionally one or more binders; optionally one or more conductive materials; and optionally one or more additives.

In some embodiments, the anode composition as described herein may comprise micro silicon active material particles, wherein the micro silicon active material particles have (i) a measured BET surface area between about 0.1 m²/g and about 10 m²/g and (ii) a D₅₀ particle size between about 0.1 μm and about 10 μm, or (iii) a ratio of D₅₀:BET surface area between about 0.1 and 10, wherein the micro silicon active material particles are coated, and wherein the amount of the coated micro silicon active material particles present in the anode composition is between about 60 wt. % and about 95 wt. % based on the total weight % of the anode composition; optionally one or more further active materials, optionally one or more binders; optionally one or more conductive materials; and optionally one or more additives.

In some embodiments or examples, the micro silicon active material particles content of the anode composition may be between about 60 wt. % and about 95 wt. % based on the total weight of the anode composition. It will be appreciated that further advantages may be shown when the micro silicon active material particles content of the anode composition is greater than 60 wt. %, preferably greater than 70 wt. %. The micro silicon active material particles content may be less than about 95 wt. %, 90 wt. %, 85 wt. %, 80 wt. %, 75 wt. %, 70 wt. %, 65 wt. %, or 60 wt. %. The micro silicon active material particles content may be at least about 60 wt. %, 65 wt. %, 70 wt. %, 75 wt. %, 80 wt. %, 85 wt. %, 90 wt. %, or 95 wt. c. The micro silicon active material particles content of the anode composition may be in a range provided by any two of these upper and/or lower amounts.

In some embodiments or examples, the thickness of the anode composition may be substantially uniform and in the range of about 5 μm to about 70 μm. The thickness (μm) of the anode composition may be less than about 70, 65, 60, 55, 50, 45, 40, 35, 30, 25, 20, 15, 10, or 5. The thickness (μm) of the anode composition may be at least about 5, 10, 15, 20, 25, 30, 35, 40, 45, 50, 55, 60 or 65. The thickness of the anode composition may be in a range provided by any two of these upper and/or lower amounts.

In some embodiments or examples, the anode composition may be supported on a current collector material. In some embodiments or examples, the anode composition may be applied to the current collector material as a coating or film. It will be understood that the current collector may be at least partially coated with the anode composition. For example, the anode composition may be applied to only one side of the current collector material. The current collector material for the anode may be selected from the group comprising copper, aluminium, stainless steel, titanium, carbon, perforated metal foils, metal foams, and metal coated polymer based porous and non-porous membranes. It will be appreciated that the current collector material will be of appropriate dimension, porosity and pore size, encompassing the above materials and acting as the current collector. For example, the anode composition may be applied to a copper current collector material (e.g. copper foil). For example, the anode composition, comprising or consisting of micro silicon active material particles, optionally one or more further active materials, optionally one or more binders, optionally one or more conductive materials, and optionally one or more additives, may be supported on a copper current collector material (e.g. copper foil). In some embodiments, the current collector material for the anode may have a thickness of between about 4 μm and about 25 μm. The thickness of the current collector (in μm) may be less than about 25, 20, 15, 10, 8, 6, or 4. The thickness of the current collector (in μm) may be at least about 4, 5, 6, 7, 8, 9, 10, 12, 14, 16, 18, 20, or 25. The thickness of the current collector (in μm) may be in a range provided by any two of these upper and/or lower amounts. In one example, the current collector material for the anode may be copper foil having a thickness of between about 6 μm and about 12 μm.

In some embodiments or examples, the anode composition may be an anode for a battery. For example, the anode composition may be an anode for a lithium ion battery.

The present disclosure may also be directed to an anode composition comprising a coating. In some embodiments or examples, the coating may be a coating of the micro silicon active material particles which are subsequently incorporated into the anode composition. In other embodiments or examples, the coating may be a coating of the anode composition or anode itself. In other words, the coating may be present on at least a portion of the surface of the anode composition and the anode so formed. In some embodiments or examples, the portion (%) may be at least about 5, 10, 15, 20, 25, 30, 35, 40, 45, 50, 55, 60, 65, 70, 75, 80, 85, 90, 95, or 100.

In some embodiments, the coating may be selected from the group comprising carbon, graphene, graphite, metal oxide, polymer, and combinations thereof, to form a coated micro silicon active material particle or a coated anode composition.

The silicon active material particles herein may be coated with a form of carbon. The carbon coating may comprise predominantly sp² hybridized carbon or predominantly sp³ hybridized carbon. The carbon coating may also comprise varying degrees of sp² and sp³ hybridization. Some embodiments of the coating may comprise a high level of sp² hybridization and a low level of sp³ hybridization or vice versa. In some embodiments the level of sp² hybridization with respect to the coating may be in between 1% to 100%. In another embodiment the level of sp³ hybridization may be in between 1% to 100%. A particular coating embodiment may comprise a level of 10%, 20%, 30%, 40%, 50%, 60%, 70%, 80, 90%, 99% or 100% sp² hybridization which may be combined with a level of sp³ hybridization of 1−% sp² hybridization*100. In other words whatever the level of sp² hybridization, in a mixed sp²/sp³ hybridization coating, the remainder of the coating is made up of the sp³ hybridization. Another coating embodiment may comprise a level of 10%, 20%, 30%, 40%, 50%, 60%, 70%, 80, 90% or 100% sp³ hybridization whereas the level of sp² hybridization is 1-% sp³ hybridization*100.

Carbon-coated silicon active material particles may be provided by coating the micro silicon active material particles, as described herein, with a carbon using one or more carbon precursors. As used herein, the term “carbon” may refer to an amorphous or a non-graphitizable carbon coating, a graphitic carbon coating, or graphene. A non-graphitizable material is a carbon material that remains substantially amorphous even when exposed to high temperatures. As discussed above, the carbon coatings may demonstrate a range of mixed sp²/sp³ hybridization. The carbon coatings may be applied using a range of techniques which are known in the art including, but not limited to, CVD, PVD, pyrolysis and the like.

In embodiments, the amorphous carbon coating may be a coating with a soft carbon or a hard carbon, as are known in the art. It will be appreciated that a wide range of precursor materials are commercially available to achieve such amorphous carbon coatings with carbon black, petroleum pitch, coal tar pitch, acetylene gas, decomposable polymers, preferably decomposable polymers with a low oxygen content, such as PVP (Polyvinylpyrrolidone), Polyacrylonitrile (PAN), polyaniline (PANi), polypyrrole (PPy), melanin resin, phenolic resin, polydopamine, resorcinol formaldehyde resin, citric acid and glucose merely being some non-limiting examples. Amorphous carbon layers may generally be obtained via pyrolytic processes, in which the micro silicon particle would be exposed to a decomposable gas such as acetylene which then deposits on the surface as a layer when heated to a sufficiently high temperature. Alternatively, they may be obtained by coating the micro silicon particles in a precursor material such as pitch or combustible polymers and pyrolyzing the pitch or polymer to form a carbon layer. Different carbon precursors can be selected to form different qualities of carbon layer. For example, aromatic compounds may form a quality coating which may have a higher degree of sp² hybridization. More linear organic compounds such as acetylene or certain polymers may form more amorphous structures with a higher degree of sp³ hybridization.

In some embodiments, graphene-coated micro silicon active material particles may be provided by coating the micro silicon active material particles, as described herein, with graphene. In some embodiments, the graphene may be selected from the group comprising graphene, graphene oxide or reduced graphene oxide and derivatives thereof. Graphite-coated micro silicon active material particles may be provided by coating the micro silicon active material particles, as described herein, with graphite. In some embodiments, the graphite may be selected from the group comprising graphite, nano graphite, graphite oxide and derivatives thereof.

Metal oxide-coated micro silicon particles may be provided by coating the micro silicon active material particles, as described herein, with a metal oxide. In some embodiments, the metal oxide may be selected from the group comprising aluminium oxide, aluminium oxide hydroxide (γ-AlO(OH)), aluminium hydroxide (Al(OH)₃), aluminium nitrate (Al(NO₃)₃) or other comparable aluminium containing species. In some embodiments the aluminium hydroxide or the aluminium nitrate may form a precursor for subsequent conversation to aluminium oxide hydroxide or aluminium oxide. In some embodiments the aluminium oxide may comprise alpha aluminium oxide. In another embodiment the metal oxide may comprise titanium or niobium based metal oxide. The metal oxide coating may comprise titanium oxide (TiO₂) or niobium oxide (Nb₂O₅). In yet another embodiment the metal oxide coating may comprise a magnesium based oxide. The magnesium based oxide may be magnesium oxide (MgO).

In embodiments, metal oxides, such as for example α-aluminium oxide and other aluminium species, may be applied to the micro silicon particles via either precipitation processes followed by calcination at higher temperatures of >400° C. or via processes such as atomic layer deposition (ALD). The precipitation process route typically involves dissolving the appropriate metal salt in water at an appropriate concentration and under controlled pH and manipulating the pH so that the metal salt uniformly precipitates on the surface of the micro silicon active material. Typically this involves raising the pH of the environment. The concentration of the metal salt in solution determines the final coating layer thickness. Excess components and metal salt may be gently washed and the micro silicon active material may be transferred into a furnace. The precipitate may be heated under air or an inert gas to a temperature of up 1200° C. which converts the metal salt precursor to the corresponding metal oxide.

Polymer-coated micro silicon active material particles may be provided by coating the micro silicon active material particles, as described herein, with a polymer. In some embodiments, the polymer may be selected from the group comprising starch, lignin, cellulose, polyacrylamide, polymethacrylamide, polyamic acid, polystyrene-4-sulfonate (PSS), 3,4-ethylenedioxythiophene/polystyrene-4-sulfonate (PEDOT:PSS), polydiallyldimethylammonium chloride PDDA, polydiallyldimethylammonium/polystyrene-4-sulfonate (PDDA:PSS), urea-pyrimidinone (UPy), urea-oligo-amidoamine (UOAA), dopamine methacrylamide, dopamine methacrylate, dopamine acrylate, dopamine, hydroxyethyl acrylate, hydroxypropyl acrylate, hydroxyethyl methacrylate, hydroxypropyl methacrylate, polyethylene glycol methyl ether methacrylate and polyethylene glycol methyl ether acrylate, natural polyisoprene, including cis-1,4-polyisoprene natural rubber and trans-1,4-polyisoprene gutta-percha, synthetic polyisoprene, polybutadiene, chloroprene rubber, polychloroprene, butyl rubber, including halogenated butyl rubbers, styrene-butadiene rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, thermoplastic elastomers, protein resilin, protein elastin, ethylene oxide-epichlorohydrin copolymer, polyurethane, urethane-urea copolymer, polyaniline, polypyrrole, polythiophene, polyfuran, bi-cyclic polymers, poly(ethylene oxide) (PEO), polypropylene oxide (PPO), poly(acrylonitrile) (PAN), poly(methyl methacrylate) (PMMA), poly(vinylidene fluoride) (PVdF), poly((bis-(methoxyethoxy) ethoxy)phosphazene), polyvinyl chloride, polydimethylsiloxane, poly(vinylidene fluoride)-hexafluoropropylene (PVDF-HFP), any derivatives thereof (e.g. sulfonated derivatives), phenolic resin, or any combination thereof.

Silane coupling agent derived coatings on micro silicon active material particles may be provided by a silane coupling agent represented by the following formula (1): Y—(CH₂)ₙ—Si—X₃ wherein Y represents a non-hydrolytic group that is capable of forming a conductive polymer moiety, a conductive coating layer, a lithium-ion conducting coating layer, a layer that advantageously interacts with the electrode binder via physical attractive forces or binding, a layer that advantageously interacts with the electrode binder via forming chemical bonds, or a combination of any of the above upon polymerization on the active material surface;
each X independently represents a hydroxyl group, or a hydrolysable group selected from the group consisting of halogen atoms, alkoxy groups, ether groups and siloxy groups;
the three X groups may be identical with or different from each other; and
n represents an integer from 0 to 3.

In some examples, Y may comprise amino, epoxy, polyethylene glycol methyl ether, polyethylene gylcol, acryloxy, methacryloxy functionalities or any combination thereof.

Examples of the silane coupling agents represented by formula (1) may include but are not limited to, aminopropyltriethoxysilane, aminopropyltrimethoxysilane, bis-gamma trimethoxysilypropylamine, aminoneohexyltrimethoxysilane.

In embodiments, the coated micro silicon active material particles or coated anode composition may be provided in any manner or embodiment as described above, including pyrolization of a coating or by chemical vapour deposition, physical vapour deposition, sputtering, or mechanical deposition.

In some embodiments or examples, the coating may be in the form of a single layer. In another embodiment, the coating may be in the form of two or more layers, for example, a plurality of layers. The coating may comprise between about 1 to 5 layers. The coating may comprise less than 5 layers, 4 layers, 3 layers, or less than 2 layers. The coating may comprise at least about 1 layer, 2 layers, 3 layers, 4 layers, or at least about 5 layers. The coating may comprise layers in a range provided by any lower and/or upper limit as previously described. It will be appreciated that each layer may be provided by a different coating. For example, the coated micro silicon active material particles or coated anode composition may comprise a coating, wherein one coating layer comprises a carbon material another coating layer comprises a metal oxide (e.g., aluminium oxide) and another layer comprises a polymeric coating, applied in any order to the micro silicon. Alternatively, the coating may be a carbon material coating and a metal oxide coating, applied in either order to the micro silicon. Further, the coating may be a carbon material coating and a polymeric coating, applied in either order to the micro silicon.

It is believed that the coatings on the micro silicon active material particles or the anode composition, as described herein, can improve cycling stability and reduce electrolyte decomposition due to electrochemical protection of the anode surface. It will be appreciated that the coating may provide the micro silicon active particles or anode composition with a number of properties including, for example, structural strength, lower surface area, reduced pulverization, electron conductivity, Li-ion conductivity, passivation and/or insulation, and ultimately improve silicon anode capacity retention.

### Silicon Particles

The present invention relates to an anode composition comprising optionally coated micro silicon active material particles. The present invention also relates to an anode composition comprising coated micro silicon active material particles.

In some embodiments or examples, the micro silicon active material particles may be selected from the group comprising or consisting of metallurgical silicon, polycrystalline silicon and monocrystalline silicon. In a preferred example, the micro silicon active material particles are metallurgical silicon.

It will be appreciated that the raw feedstock for any type of elemental silicon is quartz sand (silicon dioxide (SiO₂)). In conventional manufacturing processes, SiO₂ is reacted with carbon in arc furnaces, where the carbon may be supplied to the process in the form of coke and where were high temperatures (˜1800° C.), are applied to reduce the SiO₂ to Si and CO according to the following reaction:

SiO₂+2C→Si+2CO (1)

This reaction produces metallurgical grade silicon which may comprise impurities such as Al, Ca, Fe, Ti, P. Cu, Cr, K, V, Ni, Na and others at levels of several hundred to several thousand parts per million (ppm). Metallurgical silicon can be used in various industrial applications including steel production. However, due to the impurities, it cannot be used for electronic applications. The crystal structure of metallurgical silicon is well-defined, but it is neither as pure nor efficient at conducting electricity as monocrystalline silicon. Metallurgical silicon has a metallic crystal structure, which is characterized by its metallic bonding between atoms. In the metallic crystal structure, atoms are arranged in a repeating pattern, but lacking order.

To reduce the impurities of the metallurgical silicon down to parts per billion (ppb), further refinement is required. This process can yield a semiconductor or electronic grade Si (also referred to as polycrystalline silicon). A reaction between metallurgical silicon and dry HCl will form a trichlorosilane (SiHCl₃), which is a liquid with a boiling point of 32° C.:

Si+3HCl→SiHCl₃+H₂ (2)

It will be appreciated that some chloride impurities may also form such as FeCl₃, but due to the differences between the boiling point of these impurities and SiHCl₃, the fractional distillation technique can be used to separate the impurities. During this process, the mixture of SiHCl₃ and the chloride impurities are heated, where the vapours are condensed in different distillation towers and held at appropriate temperatures. This will enable the separation of pure SiHCl₃ from the impurities. A reaction between SiHCl₃ and H₂ will result in forming pure polycrystalline silicon.

2SiHCl₃+2H₂→2Si+6HCl (3)

The crystal structure of polycrystalline silicon is not well-defined, and the small crystals (grain) that make up the material are randomly oriented and typically less than 100 micrometers in size. The grains are separated by grain boundaries and normally have random crystallographic orientations. This results in material that is weaker than monocrystalline silicon and is less efficient at conducting electricity.

Czochralski method is used to convert the pure polycrystalline silicon to single-crystal monocrystalline silicon. A seed crystal is required to grow single-crystal material, which will act as a template for growth. Czochralski method involves heating the polycrystalline silicon in a quartz-lined graphite crucible by resistively heating it to the melting point of Si (1412° C.). Then a seed crystal is lowered into the molten material and raised slowly allowing the crystal to grow onto the seed. During the growth of the crystal a slow rotation is required to average out any temperature variations that might result in an inhomogeneous solidification.

The resulting monocrystalline silicon is often referred to as single-crystal silicon. It consists of silicon, which is characterized by its regular and repeating arrangement of atoms in a three-dimensional lattice, and free from grain limits. Monocrystalline silicon can be treated as an intrinsic semiconductor consisting only of excessively pure silicon. Monocrystalline silicon is known for its high efficiency and high purity, making it ideal for use in electronic applications. Mono-crystalline silicon can be a p-type and n-type silicon by doping with other elements.

It is well known in the art that impurities may be present in any micro silicon active material particle. It is also well known that impurities may be selectively added to any micro silicon active material particle. In some embodiments, impurities selected from the group consisting of Al, Ca, Fe, Ti, P, Cu, Cr, K, V, Ni and Na may be present in the micro silicon active material particle, for example in a total or individual amount of less than about 5000 ppm, less than about 4500 ppm, less than about 4000 ppm, less than about 3500 ppm, or less than about 3000 ppm. In an embodiment, total or individual impurities selected from the group consisting of Al, Ca, Fe, Ti, P, Cu, Cr, K, V, Ni and Na may be present in the micro silicon active material particle in a range between about 0 ppm and about 5000 ppm, preferably between about 0 ppm and about 4000 ppm, more preferably between about 0 ppm and about 3000 ppm.

In preferred embodiments or examples of the present disclosure, the micro silicon active material particles are coated micro silicon active material particles, as described herein, and the anode composition comprising the coated micro silicon active material particles may or may not be additionally coated.

In some embodiments, the micro silicon active material particle coating may be selected from the group comprising carbon, graphene, graphite, metal oxide, polymer, and combinations thereof, to form a coated micro silicon active material particle or a coated anode composition.

In some embodiments or examples, the thickness of the coating may be between about 0.1 nm and about 200 nm, or between about 0.2 nm and about 150 nm, or between about 0.3 nm and about 100 nm, or between about 0.3 nm and about 75 nm, or between about 0.3 nm and about 50 nm, or between about 0.3 nm and about 25 nm, or between about 0.3 nm and about 20 nm, or between about 0.3 nm and about 10 nm. The thickness of the coating (in nm) may be less than about 200, 175, 150, 125, 100, 90, 80, 75, 70, 65, 60, 55, 50, 45, 40, 35, 30, 25, 20, 15, 10, 8, 6, 5, 4, 3, 2, 1, 0.9, 0.8, 0.7, 0.6, 0.5, 0.4, 0.3, 0.2, or 0.1.

In some embodiments, the ratio of the coating thickness to uncoated silicon particle diameter (t/d as X: 1) may be between about 0.0001:1 to about 0.2:1, or between about 0.0001:1 to about 0.15:1, or between about 0.0001:1 to about 0.12:1, or between about 0.0001:1 to about 0.1:1, or between about 0.0001:1 to about 0.09:1, or between about 0.0001:1 to about 0.085:1. Viewed another way, in some embodiments, the ratio of the silicon particle diameter to coating thickness (d/t as 1:X) may be between about 1:100,000 to about 1:5, or between about 1:100,000 to about 1:8, or between about 1:100,000 to about 1:10, or between about 1:100,000 to about 1:12.

The silicon active material particles herein may be coated with a form of carbon. The carbon coating may comprise predominantly sp² hybridized carbon or predominantly sp³ hybridized carbon. The carbon coating may also comprise varying degrees of sp² and sp³ hybridization. Some embodiments of the coating may comprise a high level of sp² hybridization and a low level of sp³ hybridization or vice versa. In some embodiments the level of sp² hybridization with respect to the coating may be in between 1% to 100%. In another embodiment the level of sp³ hybridization may be in between 1% to 100%. A particular coating embodiment may comprise a level of 10%, 20%, 30%, 50%, 60%, 70%, 80, 90%, 99% or 100% sp² hybridization which may be combined with a level of sp³ hybridization of 1−% sp² hybridization*100. In other words whatever the level of sp² hybridization, in a mixed sp²/sp³ hybridization coating, the remainder of the coating is made up of the sp³ hybridization. Another coating embodiment may comprise a level of 10%, 20%, 30%, 50%, 60%, 70%, 80, 90% or 100% sp³ hybridization whereas the level of sp² hybridization is 1-% sp³ hybridization*100.

Carbon-coated silicon active material particles may be provided by coating the micro silicon active material particles, as described herein, with a carbon using one or more carbon precursors. As used herein, the term “carbon” may refer to an amorphous or a non-graphitizable carbon coating, a graphitic carbon coating, or graphene. A non-graphitizable material is a carbon material that remains substantially amorphous even when exposed to high temperatures. As discussed above, the carbon coatings may demonstrate a range of mixed sp²/sp³ hybridization. The carbon coatings may be applied using a range of techniques which are known in the art including, but not limited to, CVD, PVD, pyrolysis and the like.

In embodiments, the amorphous carbon coating may be a coating with a soft carbon or a hard carbon, as are known in the art. It will be appreciated that a wide range of precursor materials are commercially available to achieve such amorphous carbon coatings with carbon black, petroleum pitch, coal tar pitch, acetylene gas, decomposable polymers, preferably decomposable polymers with a low oxygen content, such as PVP (Polyvinylpyrrolidone), Polyacrylonitrile (PAN), polyaniline (PANi), polypyrrole (PPy), melanin resin, phenolic resin, polydopamine, resorcinol formaldehyde resin, citric acid and glucose merely being some non-limiting examples. Amorphous carbon layers may generally be obtained via pyrolytic processes, in which the micro silicon particle would be exposed to a decomposable gas such as acetylene which then deposits on the surface as a layer when heated to a sufficiently high temperature. Alternatively, they may be obtained by coating the micro silicon particles in a precursor material such as pitch or combustible polymers and pyrolyzing the pitch or polymer to form a carbon layer. Different carbon precursors can be selected to form different qualities of carbon layer. For example, aromatic compounds may form a quality coating which may have a higher degree of sp² hybridization. More linear organic compounds such as acetylene or certain polymers may form more amorphous structures with a higher degree of sp³ hybridization.

In some embodiments, graphene-coated micro silicon active material particles may be provided by coating the micro silicon active material particles, as described herein, with graphene. In some embodiments, the graphene may be selected from the group comprising graphene, graphene oxide or reduced graphene oxide and derivatives thereof. Graphite-coated micro silicon active material particles may be provided by coating the micro silicon active material particles, as described herein, with graphite. In some embodiments, the graphite may be selected from the group comprising graphite, nano graphite, graphite oxide and derivatives thereof.

Metal oxide-coated micro silicon particles may be provided by coating the micro silicon active material particles, as described herein, with a metal oxide. In some embodiments, the metal oxide may be selected from the group comprising aluminium oxide, aluminium oxide hydroxide (γ-AlO(OH)), aluminium hydroxide (Al(OH)₃), aluminium nitrate (Al(NO₃)₃) or other comparable aluminium containing species. In some embodiments the aluminium hydroxide or the aluminium nitrate may form a precursor for subsequent conversation to aluminium oxide hydroxide or aluminium oxide. In some embodiments the aluminium oxide may comprise alpha aluminium oxide. In another embodiment the metal oxide may comprise titanium or niobium based metal oxide. The metal oxide coating may comprise titanium oxide (TiO₂) or niobium oxide (Nb₂O₅). In yet another embodiment the metal oxide coating may comprise a magnesium based oxide. The magnesium based oxide may be magnesium oxide (MgO).

In embodiments, metal oxides, such as for example α-aluminium oxide and other aluminium species, may be applied to the micro silicon particles via either precipitation processes followed by calcination at higher temperatures of >400° C. or via processes such as atomic layer deposition (ALD). The precipitation process route typically involves dissolving the appropriate metal salt in water at an appropriate concentration and under controlled pH and manipulating the pH so that the metal salt uniformly precipitates on the surface of the micro silicon active material. Typically this involves raising the pH of the environment. The concentration of the metal salt in solution determines the final coating layer thickness. Excess components and metal salt may be gently washed and the micro silicon active material may be transferred into a furnace. The precipitate may be heated under air or an inert gas to a temperature of up 1200° C. which converts the metal salt precursor to the corresponding metal oxide.

Polymer-coated micro silicon active material particles may be provided by coating the micro silicon active material particles, as described herein, with a polymer. In some embodiments, the polymer may be selected from the group comprising starch, lignin, cellulose, polyacrylamide, polymethacrylamide, polyamic acid, polystyrene-4-sulfonate (PSS), 3,4-ethylenedioxythiophene/polystyrene-4-sulfonate (PEDOT:PSS), polydiallyldimethylammonium chloride PDDA, polydiallyldimethylammonium/polystyrene-4-sulfonate (PDDA:PSS), urea-pyrimidinone (UPy), urea-oligo-amidoamine (UOAA), dopamine methacrylamide, dopamine methacrylate, dopamine acrylate, dopamine, hydroxyethyl acrylate, hydroxypropyl acrylate, hydroxyethyl methacrylate, hydroxypropyl methacrylate, polyethylene glycol methyl ether methacrylate and polyethylene glycol methyl ether acrylate, natural polyisoprene, including cis-1,4-polyisoprene natural rubber and trans-1,4-polyisoprene gutta-percha, synthetic polyisoprene, polybutadiene, chloroprene rubber, polychloroprene, butyl rubber, including halogenated butyl rubbers, styrene-butadiene rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, thermoplastic elastomers, protein resilin, protein elastin, ethylene oxide-epichlorohydrin copolymer, polyurethane, urethane-urea copolymer, polyaniline, polypyrrole, polythiophene, polyfuran, bi-cyclic polymers, poly(ethylene oxide) (PEO), polypropylene oxide (PPO), poly(acrylonitrile) (PAN), poly(methyl methacrylate) (PMMA), poly(vinylidene fluoride) (PVdF), poly((bis-(methoxyethoxy) ethoxy)phosphazene), polyvinyl chloride, polydimethylsiloxane, poly(vinylidene fluoride)-hexafluoropropylene (PVDF-HFP), any derivatives thereof (e.g. sulfonated derivatives), phenolic resin, or any combination thereof.

In some embodiments, the coated micro silicon active material particles may be provided from precipitation, pyrolization of a precursor formulation coating or by chemical vapour deposition, physical vapour deposition, atomic layer deposition sputtering, or mechanical deposition.

In some embodiments or examples, the coating may be in the form of a single layer. In another embodiment, the coating may be in the form of two or more layers, for example, a plurality of layers. The coating may comprise between about 1 to 5 layers. The coating may comprise less than 5 layers, 4 layers, 3 layers, or less than 2 layers. The coating may comprise at least about 1 layer, 2 layers, 3 layers, 4 layers, or at least about 5 layers. The coating may comprise layers in a range provided by any lower and/or upper limit as previously described. It will be appreciated that each layer may be provided by a different coating. For example, the coated micro silicon active material particles or coated anode composition may comprise a coating, wherein one coating layer comprises a carbon material another coating layer comprises a metal oxide (e.g., aluminium oxide) and another layer comprises a polymeric coating, applied in any order to the micro silicon. Alternatively, the coating may be a carbon material coating and a metal oxide coating, applied in either order to the micro silicon. Further, the coating may be a carbon material coating and a polymeric coating, applied in either order to the micro silicon.

It is believed that the coatings on the micro silicon active material particles, as described herein, can improve cycling stability and reduce electrolyte decomposition due to electrochemical protection of the anode surface. It will be appreciated that the coating may provide the micro silicon active particles with a number of properties including, for example, structural strength, lower surface area, reduced pulverization, electron conductivity, Li-ion conductivity, and/or insulation, and ultimately improve silicon anode capacity retention.

In one embodiment, the micro silicon active material particles or coated micro silicon active material particles may present any morphology, for example they may take the form of flakes, agglomerates, granules, powders, spheres, pulverized materials or the like, as well as combinations thereof. The micro silicon active material particles or coated micro silicon active material particles may have any desired shape including, but not limited to, cubic, rod like, plate-like, polyhedral, spherical or semi-spherical, quasi spherical, rounded or semi-rounded, angular, irregular, and so forth. In one embodiment, the micro silicon active material particles or coated micro silicon active material particles have an aspect ratio (i.e. the ratio of a length to a width, where the length and width are measured perpendicular to one another, and the length refers to the longest linearly measured dimension) of 1.0 to 10.0, 1.0 to 5.0, or 1.0 to 2.0. In one embodiment, the micro silicon active material particles or coated micro silicon active material particles may have an aspect ratio of about 1.0 to 5.0 or about 1.0 to 4.0 or about 1.0 to about 3.0, or about 1.0 to about 2.0, for example about 1.0, 1.5, 2.0, 2.5, 3.0, 3.5, 4.0, 4.5 or 5.0.

In some embodiments, the particle size (in μm) of the micro silicon active material particles or coated micro silicon active material particles may be at least about 0.5, 1, 2, 3, 4, 5, 6, 7, 8, 9, 10, 15, 20, 25, or 30. In some embodiments, the particle size (in μm) of the micro silicon active material particles or coated micro silicon active material particles may be less than about 30, 25, 20, 15, 10, 9, 8, 7, 6, 5, 4, 3, 2, 1, or 0.5. Combinations of any two or more of these upper and/or lower particle sizes are also possible, for example the particle size (in μm) of the micro silicon active material particles or coated micro silicon active material particles may be between about 1 to about 10, about 2 to about 8, about 3 to about 6, or about 2 to about 5. The particle size is taken to be the longest cross-sectional diameter across a micro silicon active material particle or coated micro silicon active material particle. For non-spherical micro silicon active material particles or non-spherical coated micro silicon active material particles, the particle size is taken to be the distance corresponding to the longest cross-section dimension across the particle.

The micro silicon active material particles may have a particle size distribution, wherein 90% of the micro silicon active material particles (D₉₀) have a particle size of less than about 50, 45, 40, 35, 34, 32, 30, 28, 24, 20, 18, 16, 14, 12, 10, 8, 6, 5 or 4 μm, wherein 50% of the micro silicon active material particles (D₅₀) have a particle size (in μm) of less than about 10, 9, 8, 7, 6, 5, 4, 3, 2 1, 0.9, 0.8, 0.7, 0.6, 0.5, 0.4, 0.3, 0.2, or 0.1, or wherein 10% of the micro silicon active material particles (D₁₀) have a particle size of less than about 4, 3, 2, or 1. In some embodiments, the micro silicon active material particles have a (D₅₀) particle size (in μm) of at least about 0.1, 0.2, 0.3, 0.4, 0.5, 0.6, 0.7, 0.8, 0.9, 1, 2, 3, 4, 5, 6, 7, 8, 9 or 10. In some embodiments, the micro silicon active material particles have a (D₅₀) particle size (in μm) of less than about 10, 9, 8, 7, 6, 5, 4, 3.5, 3, 2.5, 2, 1.5, 1, 0.9, 0.8, 0.7, 0.6, 0.5, 0.4, 0.3, 0.2, or 0.1. Combinations of any two or more of these upper and/or lower particle sizes are also possible, for example the micro silicon active material particles have a (D₅₀) particle size (in μm) of between about 0.1 to about 10, about 0.1 to about 9, about 0.1 to about 8, about 0.1 to about 7, about 0.1 to about 6, about 0.1 to about 5, about 0.5 to about 10, about 0.5 to about 9, about 0.5 to about 8, about 0.5 to about 7, about 0.5 to about 6, about 0.5 to about 5, about 1 to about 10, about 1 to about 9, about 1 to about 8, about 1 to about 7, about 1 to about 6, or about 1 to about 5.

In some embodiments or examples, the micro silicon active material particles may have a BET surface area in a range of from about 0.1 m²/g to about 10 m²/g, for example from about 0.1 m²/g to about 5 m²/g. The micro silicon active material particles may have a BET surface area (m²/g) of at least about 0.1, 0.2 0.3, 0.4, 0.5, 0.6, 0.7, 0.8, 0.9, 1, 2, 3, 4, 5, 6, 7, 8, 9 or 10 m²/g. In other embodiments or examples, the micro silicon active material particles may have a surface area (m²/g) of less than about 10, 9, 8, 7, 6, 5, 4, 3, 2 1, 0.9, 0.8, 0.7, 0.6, 0.5, 0.4, 0.3, 0.2, or 0.1 m²/g. Combinations of these surface area values to form various ranges are also possible, for example the micro silicon active material particles may have a surface area of between about 0.1 to about 10, about 0.1 to about 9, about 0.1 to about 8, about 0.1 to about 7, about 0.1 to about 6, about 0.1 to about 5, about 0.5 to about 10, about 0.5 to about 9, about 0.5 to about 8, about 0.5 to about 7, about 0.5 to about 6, about 0.5 to about 5, about 1 to about 10, about 1 to about 9, about 1 to about 8, about 1 to about 7, about 1 to about 6, or about 1 to about 5.

In some embodiments or examples, the coated micro silicon active material particles may have a BET surface area in a range of from about 0.1 m²/g to about 90 m²/g. The coated micro silicon active material particles may have a BET surface area (m²/g) of at least about 0.1, 0.5, 1, 2, 3, 4, 5, 6, 7, 8, 9 10, 15, 20, 25, 30, 35, 40, 45, 50, 60, 70, 80, or 90 m²/g. In other embodiments or examples, the coated micro silicon active material particles may have a surface area (m²/g) of less than about 90, 80, 70, 60, 50, 40, 30, 20, 10, 9, 8, 7, 6, 5, 4, 3, 2, 1, 0.5, or 0.1 m²/g. Combinations of these surface area values to form various ranges are also possible.

The inventors have surprisingly found that there is a relationship between the D₅₀ particle size (in μm) of the uncoated micro silicon active material particles and the BET surface area (m²/g) of the uncoated micro silicon active material particles, and the ratio of those parameters to the electrochemical performance of the anode. In some embodiments or examples, the ratio of D₅₀ particle size (in μm) of the micro silicon active material particles and the BET surface area (m²/g) of the micro silicon active material particles may be in a range from about 0.1 to about 10. In some embodiments or examples, the ratio of D₅₀ particle size (in μm) of the micro silicon active material particles and the BET surface area (m²/g) of the micro silicon active material particles may be at least about 0.1, 0.2, 0.3, 0.4, 0.5, 0.6, 0.7, 0.8, 0.9, 1, 2, 3, 4, 5, 6, 7, 8, 9, or 10. In some embodiments or examples, the ratio of D₅₀ particle size (in μm) of the micro silicon active material particles and the BET surface area (m²/g) of the micro silicon active material particles may be less than about 10, 9, 8, 7, 6, 5, 4, 3, 2, 1, 0.9, 0.8, 0.7, 0.6, 0.5, 0.4, 0.3, 0.2, or 0.1. Combinations of these ratios to form various ranges are also possible, for example the ratio of D₅₀ particle size (in μm) of the uncoated micro silicon active material particles and the BET surface area (m²/g) of the uncoated micro silicon active material particles may be in a range of between about 0.1 to about 10, about 0.1 to about 9, about 0.1 to about 8, about 0.1 to about 7, about 0.1 to about 6, about 0.1 to about 5, about 0.5 to about 10, about 0.5 to about 9, about 0.5 to about 8, about 0.5 to about 7, about 0.5 to about 6, about 0.5 to about 5, about 1 to about 10, about 1 to about 9, about 1 to about 8, about 1 to about 7, about 1 to about 6, or about 1 to about 5. For example, a ratio of D₅₀ particle size (in μm) of the micro silicon active material particles and the BET surface area (m²/g) of the micro silicon active material particles in the range of about 0.1 to about 6 provided by a D₅₀ and BET surface area range of about 2 μm to about 8 μm and about 1 m²/g to about 5 m²/g, respectively, improve the initial coulombic efficiency and capacity retention of the anode. In particular, a ratio of D₅₀ particle size (in μm) of the micro silicon active material particles and the BET surface area (m²/g) of the micro silicon active material particles in the range of about 1.0 to about 3.5 provided by a D₅₀ particle size and BET surface area range of about 3.0 μm to about 6.0 μm and about 1.0 m²/g to about 3.5 m²/g, respectively, advantageously provided the most improved capacity retention in the full cell configuration for the micro silicon anode design. It will be appreciated that a gradual decrease in electrochemical performance is found when the D₅₀ particle size/BET surface area ratio is higher than 3.5 and lower than 1.0. However, a drastic decrease in ICE and capacity retention is found when the D₅₀ particle size/BET surface area ratio is between 0.01 and 0.10 resulting from a D₅₀ particle size range of 0.1 to 2.0 μm and a BET surface of >5 m²/g. Without wishing to be bound by theory, this phenomenon is likely to result from the low surface reactivity of the micro silicon active material particle with the electrolyte forming a thinner and less resistive SEI layer.

It was surprisingly found that an inverse relationship of cycling stability exists when various micro silicon anode grades were cycled in half-cell and full-cell designs, which was governed by their respective particle size, BET surface area and the ratio between the d₅₀ particle size and BET surface area.

In half-cell format where the micro silicon anode is tested under fully lithiated conditions, a fast capacity reduction was evident for samples with a d₅₀>2.0 μm, BET surface area<5 m²/g and a d₅₀ particle size:BET surface area ratio higher than 0.01 to 0.1. When the micro silicon materials are tested at limited capacity full-cell design, the cycling stability observed from the half-cell testing were inversed. Micro silicon materials with a high d₅₀ particle size (preferably 2.0-8.0 μm), low BET surface area (preferably 1.0-5.0 m²/g) and high d₅₀ particle size:BET surface area ratio (preferably 0.1-6.0) result in stable cycling performance with a higher ICE and capacity retention.

Expansion and shrinkage of silicon particles upon charge-discharge cycling causes pulverization of silicon particles, which increases their specific surface area. With an unlimited supply of Lit ions from the Li metal counter electrode in half-cells, any Li loss from SEI formation reactions with newly formed surfaces can be easily compensated and the Si anode can continue to cycle until the silicon electrode is completely exhausted. Therefore, micro silicon particles with a low d₅₀, high BET surface area and a d₅₀ particle size:BET surface area ratio<0.1 will take longer to reach the complete exhaustion of the silicon electrode due to the presence of a larger silicon surface area, lower average particle size and therefore reduced stresses on the particles, resulting in a relatively stable cycling performance.

In full cell designs where a limited Li reservoir is present, the increased reactivity of micro silicon particles with a larger surface area consisting of a d₅₀<2.0 μm, BET surface area>5 m²/g and a d₅₀ particle size:BET surface area ratio<0.1 during charge-discharge leads to accelerated consumption of Lit leading to poor capacity retention and cycle life. The low surface reactivity and thus the low irreversible consumption of Lit ions in the micro silicon materials with a high d₅₀ particle size (preferably 2.0-8.0 μm), low BET surface area (preferably 1.0-5.0 m²/g) and high d₅₀ particle size:BET surface area ratio (preferably 0.1-6.0) during cycling extend the capacity retention and cycle life. It was surprisingly found that specific combinations of d₅₀ and BET surface area can lead to exceptionally good performance in full cells.

In some embodiments or examples, the tap density of the micro silicon active material particles or the coated micro silicon active material particles may be in a range of from about 0.5 g/cm³ to about 1.5 g/cm³. The tap density of the micro silicon active material particles or the coated micro silicon active material particles may be at least about 0.5, 0.55, 0.6, 0.65, 0.7, 0.75, 0.8, 0.85, 0.9, 0.95, 1.0, 1.2, 1.3 or 1.5 g/cm³. In other embodiments or examples, the tap density of the micro silicon active material particles or the coated micro silicon active material particles may be less than about 1.5, 1.4, 1.3, 1.2, 1.0, 0.95, 0.9, 0.85, 0.8, 0.75, 0.7, 0.65, 0.6, 0.55, or 0.5 g/cm³. Combinations of these density values to form various ranges are also possible, for example the micro silicon active material particles or the coated micro silicon active material particles may have a tap density of between about 0.5 g/cm³ to about 1.2 g/cm³. The density can be measured by any standard method, for example in accordance with ASTM D7481-18.

Advantageously, the micro silicon active material particles of the present disclosure may be provided in a high purity. In an embodiment or example, the purity of micro silicon active material particles (without oxygen) may be in a range from (by wt. %) about 95 to about 99.9. The purity of micro silicon active material particles (without oxygen) may be at least (by wt. c) about 95, 96, 97, 98, 99, 99.5, or 99.9. The purity of the micro silicon active material particles (without oxygen) may be less than (by wt. %) about 99.9, 99.5, 99, 98, 97, 96, or 95. The purity of micro silicon active material particles (without oxygen) may be in a range provided by any lower and/or upper limit as previously described.

In an embodiment or example, the purity of micro silicon active material particles (with oxygen) may be in a range from (by wt. %) about 79 to about 99.5. The purity of micro silicon active material particles (with oxygen) may be at least (by wt. %) about 75, 80, 85, 90, 95, 96, 97, 98, 99 or 99.5. The purity of the micro silicon active material particles (with oxygen) may be less than (by wt. %) about 99.5, 99, 98, 97, 96, 95, 90, 85, 80, or 75. The purity of micro silicon active material particles (with oxygen) may be in a range provided by any lower and/or upper limit as previously described.

The combination of novel and inventive features of the micro silicon active material particles according to the present disclosure, their optional coating and their use in an optionally coated anode composition for an anode in a lithium ion battery surprisingly leads to an improvement in the batteries cycle behaviour. Alternatively, the coated micro silicon active material particles according to the present disclosure and their use in an optionally coated anode composition for an anode in a lithium ion battery may also surprisingly lead to an improvement in the batteries cycle behaviour. It was unexpectedly shown that the lithium-ion batteries, as described herein, have a small irreversible capacity loss in the first charge cycle and a stable electrochemical behaviour with minimal fading in the subsequent cycles. Therefore, with the use of the micro silicon active material particles or coated micro silicon active material particles, as described herein, a lower initial capacity loss and also a low continuous loss of capacity of the lithium-ion batteries can be achieved. Overall, the lithium-ion batteries as described herein provide very good stability and cycle life. Accordingly, a high number of cycles can be achieved with minimal fatigue, for example, as a consequence of mechanical destruction of the anode coating layer, anode material or SEI formation.

### Prelithiation

The SEI layer is formed during the intercalation of lithium-ions, where the organic electrolyte is reduced on the anode's surface when the anode potential is below about 1V versus Li+/Li. The SEI layer is crucial in preventing the co-intercalation of electrolyte ions into the bulk electrode material, by creating a film that is electrically insulating but ionically conductive. This prevents ongoing excessive decomposition of the electrolyte. However, during the formation of the SEI layer film on the surface of the anode active material, some lithium ions may be irreversibly trapped in the electrode, leading to the consumption of lithium ions.

The initial irreversible lithium loss of anodes can be compensated by adding lithium to the anode via prelithiation. Prelithiation methods can be broadly grouped into electrochemical prelithiation and chemical prelithiation. Electrochemical prelithiation may be further grouped into half-cell prelithiation or short-circuit prelithiation. Chemical prelithiation may be further grouped into methods of chemical synthesis, solution immersion and mechanical processes. Additional methods for prelithiation that may be utilized at the active material particle of the anode coating level are represented by chemical vapor deposition (CVD) type methods and physical vapor deposition methods (PVD). The preferred methods to prelithiate an anode coating include methods that also pre-form an SEI layer and can be carried out in a roll-to-roll process and are cost effective in nature. It will be understood that the preferred prelithiation methods to prelithiate the an active material particle before incorporation into an anode coating may differ from the methods that are used to prelithiate an anode composition. It will be understood that the prelithiation at the particle level may be carried out before a coating layer is applied to the particle. It should be noted that the current disclosure is not limited to a particular method of prelithiation and that the most suitable method will be chosen to achieve the intended outcome.

Prelithiation may be applied to anode electrodes. For example, prelithiation may be applied to compensate for the lithium that is lost on first cycle which constitutes one full charge and one full discharge of the electrochemical cell. If the amount of prelithiation is chosen such that an SEI layer is formed but no lithium is intercalated or alloyed with the active material before assembly into a full cell, then the first cycle loss of the anode once incorporated into a full cell will be minimized and any further loss of lithium is expected to be contributed from other sources such as the cathode electrode. The result is that the electrochemical cell now cycles at a higher cell capacity as more lithium is available in subsequent cycles to be passed back and forth between the anode and the cathode during repeated charge and discharge cycling.

Prelithiation may also provide a lithium reservoir in the anode before the anode is assembled into a cell assembly in addition to compensating for any lithium loss that occurs during the first cycle and more generally the initial formation cycles. The lithium reservoir may compensate for ongoing lithium losses over a number of cycles thus reducing capacity fade and extending the useful life of the full cell. In other words, prelithiation may provide one or more advantages for silicon containing anodes and in particular for anodes that contain a high percentage of silicon. Providing the anode with a lithium reservoir using a method that also applies an SEI layer to the active material can also maximize the first cycle efficiency of the cell.

Optionally, the anode composition may provide a prelithiated anode composition. The prelithiation may occur at the anode active material level before the active material is incorporated into the anode composition or the prelithiation may occur after the anode composition has been prepared. One or more advantages of the present disclosure are provided by prelithiating the anode composition which can provide a lithium reservoir in the anode thereby extending its cycle life by compensating for ongoing Lit losses during charge/discharge cycling, once incorporated into a full cell arrangement.

In some embodiments, the micro silicon active material particles or coated micro silicon active material particles may be prelithiated micro silicon active material particles or coated micro silicon active material particles, wherein prelithiation occurs prior to incorporation of the active material into the anode composition. It will be appreciated that the micro silicon active material particles may be prelithiated prior to forming the coated micro silicon active material particles. In other embodiments, the micro silicon active material particles or coated micro silicon active material particles may be prelithiated micro silicon active material particles or coated micro silicon active material particles, wherein prelithiation occurs after the active material has been incorporated into the anode composition. The degree of prelithiation may be chosen such that the created phase is in between Li₀Si₁ (0% prelithiation) to Li_{4.40}Si₁ (100% prelithiation). Any phase composition in between may be desirable including Li₁Si₁, Li_{1.71}Si₂. Li₂Si₁, Li_{3.5}Si₁, and Li_{3.75}Si₁. In some embodiments or examples, the amount of prelithiation of the micro silicon active material particle and/or the anode composition may be between about 1% and about 30%. The amount of prelithiation of the micro silicon active material particle or coated micro silicon active material particle and/or the anode composition may be less than about 30%, 25%, 20%, 15%, 10%, 5% or 1%. The amount of prelithiation of the micro silicon active material particle or coated micro silicon active material particle and/or the anode composition may be at least about 1%, 5%, 10%, 15%, 20%, 25%, or 30%. The amount of prelithiation of the micro silicon active material particle or coated micro silicon active material particle and/or the anode composition may be in a range provided by any two of these upper and/or lower amounts.

Prelithiation of the micro silicon active material particles or coated micro silicon active material particles may be carried out via physical vapor deposition (PVD) or chemical vapor deposition (CVD) or mechanical alloying processes or chemical processes or electrochemical processes. It will be appreciated that a range of suitable methods may be applied to create a silicon-lithium alloy phase prior to the prelithiated micro silicon active material particles being incorporated into the anode composition.

### Further Active Materials

The anode composition as described herein may further comprise one or more further active materials. In some embodiments, the further active materials may be a graphite or a silicon. For example, flake graphite, natural graphite, artificial graphite, silicon oxide where x=0.8 to 2 (SiOx), silicon carbon composites, silicon alloys, or any combination thereof.

### Binder

The anode composition as disclosed herein may further comprise one or more binders. The binder may be a polymer. In some embodiments, the polymer may be selected from the group consisting of gum arabic, carboxymethyl cellulose (CMC)/citric acid, CMC/styrene-butadiene rubber (SBR), polytetrafluoroethylene (PTFE), polyvinylidene fluoride (PVDF), poly(l-trimethylsilyl-1-propyne) (PTMSP), gum binders such as gum arabic, Xanthan gum, and guar gum, natural cellulose based binders, polysaccharides such as sodium carboxymethyl cellulose, lithium carboxymethyl cellulose, sodium alginate, polyacrylates, aliphatic polymers such as polyvinyl butyral, aromatic polymers such as styrene-butadiene rubber. For example, the polymer may be selected from the group consisting of polyvinylpyrrolidone, carboxymethylcellulose, polyacrylic acid (PAA), poly(methacrylic acid), maleic anhydride copolymers including poly(ethylene and maleic anhydride) copolymers, polyvinyl alcohol, carboxymethyl chitosan, natural polysaccharide, Xanthan gum, alginate, polyimide and PAA copolymers including one or several of the following of polyvinylalcohol (PVA), polyurethane (PU), polyimide (PI) or polyacrylonitrile (PAN), In one example, the binder is PAA. The binder may be dissolved in H₂O or ethanol or mixtures of H₂O and ethanol or N,N′dimethylformamide or any other solvent that is suitable for the intended purpose. Some binders may be present in the form of water-based emulsions.

In some embodiments or examples, the ratio of binder to micro silicon active material particles or coated micro silicon active material particles may be about 1:40, 1:35, 1:32, 1:30, 1:25, 1:23, 1:20, 1:15, 1:10, 1:9, 1:6, or 1:4. The ratio of binder to micro silicon active material particles or coated micro silicon active material particles may be in a range of about 1:4 to about 1:32. The ratio of binder to micro silicon active material particles or coated micro silicon active material particles may be in a range of about 1:8 to about 1:23. The ratio of binder to micro silicon active material particles or coated micro silicon active material particles may be in a range of about 1:9 to about 1:15.

In some embodiments or examples, the binder (in wt. %) may be present in the anode composition in a range of about 2.5 to 15. The binder (wt. %) may be present in the anode composition in an amount of less than about 15, 12, 10, 8, 5 or 2.5. The binder (in wt. %) may be present in the anode composition in an amount of at least about 2.5%, 5%, 8%, 10%, 12%, or 15%. The binder (in wt. %) may be present in the anode composition in a range provided by any two of these upper and/or lower amounts. For example, the binder (in wt. %) may be present in the anode composition in a range of about 3 to about 8, or about 4 to about 8.

It has been found that the pH of the binder may impact the electrochemical performance of the anode composition. In some embodiments or examples, the pH of the binder may be less than 9, 8, 7, 6, 5, 4, 3, or 2. In some embodiments or examples, the pH of the binder may be at least 2, 3, 4, 5, 6, 7, 8 or 9. The pH of the binder may be in a range provided by any two of these upper and/or lower values. For example, the pH of the binder may be in a range of 4 to 8.

### Conductive Material

The anode composition as described herein may further comprise one or more conductive materials. In some embodiments or examples, the conductive material may be a carbon-based material. In an embodiment or example, the carbon-based material may be nano-sized or micro-sized carbon particles or flakes, or a combination thereof. In an embodiment or example, the carbon-based material may be selected from the group consisting of activated carbon, carbon nanoparticles, graphite, single walled (SWCNT) or multiwalled (MWCNT) carbon nanotubes, branched carbon nanotubes, carbon nanofiber, graphene, graphene oxide, MXene, nano or micro-sized hard carbons, nano or micro-sized porous carbons and conductive polymers. The carbon-based material may be selected from the group consisting of graphene, graphene oxide, graphite, single walled (SWCNT) or multiwalled (MWCNT) carbon nanotubes, branched carbon nanotubes, carbon nanofiber, MXene, nano or micro-sized hard carbons, nano or micro-sized porous carbons and conductive polymer.

In some embodiments or examples, the ratio of conductive material to micro silicon active material particles or coated micro silicon active material particles may be about 1:50, 1:48, 1:45, 1:40, 1:35, 1:30, 1:25, 1:20, 1:18, 1:15, 1:10, 1:8, 1:6, 1:4, 1:3, 1:2, or 1:1.3. The ratio of conductive material to micro silicon active material particles or coated micro silicon active material particles may be in a range of about 1:2 to about 1:30. The ratio of conductive material to micro silicon active material particles or coated micro silicon active material particles may be in a range of about 1:2 to about 1:18. The ratio of conductive material to micro silicon active material particles may be in a range of about 1:2 to about 1:15.

In some embodiments or examples, the conductive material may be present in the anode composition in a range of about 2.5 to 40 wt. % (based on total weight of the anode composition). The conductive material may be present in the anode composition in an amount (based on total weight of the anode composition) of less than about 40 wt. %, 30 wt. %, 20 wt. % 15 wt. %, 10 wt. %, 7 wt. %, 5 wt. % or 2.5 wt. %. The conductive material may be present in the anode composition in an amount (based on total weight of the anode composition) of at least about 2.5 wt. %, 5 wt. %. 7 wt. %, 10 wt. %, 15 wt. %, 20 wt. %, 30 wt. %, or 40 wt. %. The conductive material may be present in the anode composition in an amount provided by any two of these upper and/or lower amounts. For example, the conductive material may be present in the anode composition in an amount between about 7 wt. % and about 25 wt. %.

### Electrochemical Cell

The present disclosure is directed to providing improvements in anodes for an electrochemical cell. In some embodiments or examples, the present disclosure is directed to an anode for an electrochemical cell comprising an anode composition at least according to some embodiments or examples as described herein.

In some embodiments or examples, an electrochemical cell may comprise: a negative electrode, a positive electrode, at least one electrolyte, and a separator, wherein the anode comprises the anode composition as defined herein. For example, the electrochemical cell may comprise or consist: an anode; a cathode; at least one electrolyte comprising one or more electrolyte solvents; and a separator, wherein the anode comprises the anode composition as defined herein, and wherein the lithium uptake capacity of the anode is greater than the lithium release capacity of the cathode.

One or more advantages of the present disclosure is provided by the arrangement of the anode and cathode in the electrochemical cell, which has been found to be significantly important to increase the stability and cycle life of the anode composition described herein.

In some embodiments, capacity limitation may be considered in terms of mass loading or area capacity. Mass loading or area capacity refers to an electrochemical cell assembly where the capacity of the anode may be significantly oversized relative to the cathode. The capacity limitation may have the effect of limiting the capacity of the oversized electrode (anode) by only allowing for a partial lithiation to occur as the amount of lithium that is contained in the electrochemical cell is limited by the lithium contained in the cathode upon cell assembly. For example, in an electrochemical cell assembly where the anode possesses an area capacity of x and the cathode possesses an area capacity of y the resulting estimated percentage capacity limitation is calculated by y/x*100. It will be appreciated that this approach to capacity limitation may be particularly useful in situations where the anode contains a high percentage of elemental silicon as the active material which offers specific capacities in excess of 3500 mAh/g.

It will be appreciated that the specific area capacity (in mAh/cm²) corresponds to a specific loading weight (in mg/cm²) provided by the amount of anode composition applied to the current collector. The specific loading weight (in mg/cm²) is based on the total weight of the anode composition, including the micro silicon active material particles, one or more optional further active materials, one or more optional binders, and one or more optional conductive materials. The specific area capacity (in mAh/cm²) is dependent on thickness of the anode composition coating on the current collector, the silicon content in the anode composition, and the degree utilization of the silicon.

In some embodiments, the specific area capacity (in mAh/cm²) corresponding to the full utilization of the active materials contained within the anode composition of the anode may be in between 2.5 mAh/cm² to 20 mAh/cm².

In some embodiments, the specific loading weight (in mg/cm²) of the anode composition may be in between 0.95 mg/cm² to 7.5 mg/cm².

In some embodiments the anode and cathode are arranged in a way so that the cathode can deliver about 0.5 mAh/cm² to about 6 mAh/cm² and the anode can deliver about 1500 mAh/g. 1200 mAh/g, 1000 mAh/g. 800 mAh/g, 600 mAh/g, 500 mAh/g or 400 mAh/g. In another embodiment, the anode and cathode are arranged in a way so that the cathode can deliver about 0.5 mAh/cm² to about 6 mAh/cm² and the anode may be utilized to about 80%, 75%, 70%, 65%, 60%, 55%, 50%, 45%, 40%, 35%, 30%, 25%, or 20%.

In other embodiments, capacity limitation may be considered in terms of the phase composition of the LiSi alloy. For example, Li_{3.75}Si₁ or Li_{4.4}Si₁ corresponds to the maximum accessible capacity of 3590 mAh/g or the highest theoretical state of lithitation of 4200 mAh/g. It will be understood that if utilization of the anode is limited this may translate into specific phase compositions of the LiSi alloy. Specific phase compositions may also translate into a specific capacity (mAh/g). For example, Li_{1.71}Si₁ may correspond to a specific capacity of up to 1636 mAh/g, Li_{2.33}Si₁ may correspond to a specific capacity of up to 2227 mAh/g, Li_{3.25}Si₁ may correspond to a specific capacity of up to 3101 mAh/g, Li_{3.75}Si₁ may correspond to a specific capacity of up to 3579 mAh/g and Li_{4.4}Si₁ may correspond to a specific capacity of up to 4199 mAh/g.

In yet another embodiment, capacity limitation may be considered in terms of the voltage of the anode during charge and/or discharge. It will be understood that amount of silicon lithiation after discharge may be configured by a discharge voltage of the anode.

For example, it will be appreciated that the N/P ratio balance between anode and cathode may be in between about 1.05 and about 7, and/or the voltage range may be controlled with respect to level of discharge of the electrochemical cell. In some embodiments or examples, the capacity of the lithium uptake capacity of the anode may not be fully utilized during charging of the lithium ion battery. In some embodiments or examples, the specific area capacity of the anode may be greater than the specific area capacity of the cathode. In other words, the anode is only partially lithiated in the fully charged state. Fully charged refers to the state of the electrochemical cell (e.g., Li-ion battery) in which the anode, in particular the micro silicon active material, has its highest degree of lithiation in accordance with the invention described herein. Partial lithiation of the anode means that the maximum lithium uptake capacity of the anode active material in the anode is not fully exploited. In some embodiments, the amount of lithium stored in the cathode (mAh/cm²) may be at least 0.05 to 7.0 times smaller than the lithium storage capacity of the anode (mAh/cm²).

In some embodiments, the Li/Si ratio of an electrochemical cell (e.g. Li-ion battery) may be set by the anode to cathode ratio (N/P). In some embodiments, the N/P ratio between anode and cathode may be in between about 1.05 and about 7, about 2 and about 5, or about 3 and about 4. The N/P ratio may be than about 7, 6, 5, 4, 3, 2, or 1.05. The N/P ratio may be at least about 1.05, 2, 3, 4, 5, 6, or 7. The N/P ratio may be in a range provided by any two of these upper and/or lower values. For example, the N/P ratio between anode and cathode may be in between about 1.5 and about 4, or between about 1.8 and about 3.5.

In some embodiments, the capacity limitation (in %) may be at least about 20, 25, 30, 35, 40, 45, 50, 55, 60, 65, 70, 75, 0, 85, 90, 95, or 99. In some embodiments, the capacity limitation (in %) may be less than about 99, 95, 90, 85, 80, 75, 70, 65, 60, 55, 50, 45, 40, 35, 30, 25, or 20. The capacity limitation (in %) may be in a range provided by any two of these upper and/or lower values. For example, the capacity limitation (in %) may be in between about 25 and about 90, or between about 30 and about 80.

The present disclosure advantageously provides an electrochemical cell that is designed so that the lithium uptake capacity of the anode is greater than the lithium release capacity of the cathode. This leads to the lithium uptake capacity of the anode not being fully exploited, i.e. the silicon active material particles of the anode being only partially lithiated, in the fully charged state, and advantageously reducing or preventing the high volume change typically found for silicon anodes during lithiation/delithiation cycling, which degrades their structure and shortens the lifetime of the battery. In other words, a high N/P ratio may limit the degree of lithiation of the micro silicon, as the amount of Li ion is fixed by the cathode upon cell assembly. For example, the anode may be significantly oversized relative to the amount of lithium that is contained in the cell and provided by the cathode. As the degree of lithiation is limited by the oversized anode so is the level of expansion of the micro silicon active material particles or coated micro silicon active material particles and its degradation. In some embodiments or examples, the degree of silicon lithiation may be in a range of about 20% to about 80%. Unexpectedly, the degree of silicon lithium in this range may have a stabilizing effect on the electrochemical cells performance.

In another embodiment, the capacity of the electrochemical cell can be limited by limiting the lower cut-off voltage. In some embodiments or examples, the lower cut-off voltage may be between about 2.5V and about 3.0V. For example, the lower cut-off voltage may be between 2.8V and about 3.0V. It will be appreciated that a voltage limitation may be applied by restricting the lower cut-off voltage. This can prevent the complete delithiation of the micro silicon active material particles or coated micro silicon active material particles at each cycle and mitigate its expansion, leading to less degradation and consequently extended cycle life.

In another embodiment, the capacity of the electrochemical cell can be limited by limiting the upper cut-off voltage. In some embodiments or examples, the upper cut-off voltage may be between about 3.6V and about 4.25V.

It will be appreciated that both limitations, by capacity and voltage may be used simultaneously.

It will be understood that the anode composition may be prelithiated as described in any one of more of the embodiments or examples described hereon. In some embodiments, prelithiation may occur prior to incorporation of the active material into the anode composition. In other embodiments, prelithiation may occur after the active material has been incorporated into the anode composition. In some embodiments or examples, the amount of prelithiation of the anode composition may be between about 1% and about 30%. The amount of prelithiation of the anode composition may be less than about 30%, 25%, 20%, 15%, 10%, 5% or 1%. The amount of prelithiation of the anode composition may be at least about 1%, 5%, 10%, 15%, 20%, 25%, or 30%. The amount of prelithiation of the anode composition may be in a range provided by any two of these upper and/or lower amounts.

In some embodiments, the amount of lithium contained in the anode may be about 30% of its maximum storage capacity while the cathode may contain 100% of its maximum storage capacity. In some embodiments, the amount of lithium contained in the anode may be about 20% of its maximum storage capacity while the cathode may contain 100% of its maximum storage capacity. In some embodiments, the amount of lithium contained in the anode may be about 10% of its maximum storage capacity while the cathode may contain 100% of its maximum storage capacity.

In one embodiment, to perform an electrochemical prelithiation a half-cell method may be used. A silicon containing electrode is assembled in a half cell set-up using a lithium foil reference electrode and the degree of prelithiation is controlled by setting the appropriate parameters in a galvanostatic charge/discharge cycling program. To create the SEI layer and a lithium reservoir of up to 0% lithium in the anode, the half-cell will go through the first cycle by partially or fully lithiating the silicon containing electrode followed by full delithiation.

Whereas when creating a lithium reservoir in the anode a partial lithiation up to the desired degree of lithium reservoir is required. Subject to the composition and associated material properties of the silicon containing anode a first cycle loss can be estimated upon having tested the corresponding composition in a half cell against a lithium metal foil reference electrode and having so determined the anode compositions first cycle loss. If the first cycle loss is estimated to be x %, then to create a lithium reservoir of y %, the initial lithiation step during the prelithiation process needed to achieve a lithiation level of the silicon anode composition of z % needs to account for x %+y %. If in one particular embodiment an anode composition shows a first cycle loss of 10%, then this loss needs to be taken into account when calculating the desired degree of prelithiation to obtain the resulting lithium reservoir. For example, to achieve a 10% lithium reservoir the anode may be lithiated up to 20% of its expected design capacity (mAh/g) where the initial ˜10% aim to compensate for the irreversible lithium loss during the first cycle and the additional are stored in the anode or the silicon material and thus form the desired lithium reservoir. It will be understood that higher levels of prelithiation may be applied to achieve other desired levels of lithium reservoirs. The maximum desired level of a lithium reservoir may be 30%.

It is believed that pairing prelithiation and capacity limitation may provide the electrochemical cell of the present disclosure with one or more further advantages. For example, while the capacity of the anode that is occupied by lithium that is supplied by the cathode and stored in the anode on first lithiation will be the same with and without prelithiation notwithstanding any loss of lithium on first cycle, the lithium reservoir in the anode can compensate for the gradual loss of lithium during repeated charge and discharge cycling for a number of cycles.

In some embodiments, the anode composition may be applied to a current collector material as a coating or film. The current collector material for the anode may be selected from the group comprising copper, aluminium, stainless steel, titanium, carbon, perforated metal foils, metal foams, and metal coated polymer based porous and non-porous membranes. For example, the anode composition may be applied to a copper current collector material (e.g. copper foil).

In some embodiments, the current collector material for the anode may have a thickness of between about 4 μm and about 25 μm. The thickness of the current collector (in μm) may be less than about 25, 20, 15, 10, 8, 6, or 4. The thickness of the current collector (in μm) may be at least about 4, 5, 6, 7, 8, 9, 10, 12, 14, 16, 18, 20, or 25. The thickness of the current collector (in μm) may be in a range provided by any two of these upper and/or lower amounts. In one example, the current collector material for the anode may be copper foil having a thickness of between about 6 μm and about 12 μm.

In some embodiments or examples, the thickness of the anode composition may be substantially uniform and in the range of about 5 μm to about 70 μm. The thickness (μm) of the anode composition may be less than about 70, 65, 60, 55, 50, 45, 40, 35, 30, 25, 20, 15, 10, or 5. The thickness (μm) of the anode composition may be at least about 5, 10, 15, 20, 25, 30, 35, 40, 45, 50, 55, 60 or 65. The thickness of the anode composition may be in a range provided by any two of these upper and/or lower amounts.

It will be appreciated that the cathode active material is also applied to a current collector material. The current collector material for the anode may be selected from the group comprising copper, aluminium, stainless steel, titanium, carbon, perforated metal foils, metal foams, and metal coated polymer based porous and non-porous membranes. For example, the cathode composition may be applied to an aluminium current collector material (e.g. aluminium foil).

In some embodiments, the current collector material for the cathode may have a thickness of between about 10 μm and about 30 μm. The thickness of the current collector (in μm) may be less than about 30, 25, 20, 15, or 10. The thickness of the current collector (in μm) may be at least about 10, 12, 14, 16, 18, 20, 25, or 30. The thickness of the current collector (in μm) may be in a range provided by any two of these upper and/or lower amounts. In one example, the current collector material for the cathode may be aluminium foil having a thickness of between about 10 μm and about 30 μm.

In some embodiments, the cathode may be selected from the group consisting of lithium nickel cobalt manganese oxide (NCM), lithium iron phosphate (LFP), lithium nickel manganese spinel (LNMO), lithium nickel cobalt aluminium oxide (NCA), lithium manganese oxide (LMO), lithium cobalt oxide (LCO), and sulphur or sulphur composite including sulphur and carbon mixtures.

In some embodiments or examples, the electrolytes may be selected from a non-aqueous solution of one or more lithium salts (e.g. in Li-ion cells). The one or more lithium salts may be selected from the group comprising lithium bis(trifluoromethane sulfone)imide, lithium hexafluorophosphate, lithium hexafluoroarsenate, lithium bis(trifluorosulfonylimide), lithium trifluoromethanesulfonate, lithium fluoroalkylsulfonimides, lithium fluoroarylsulfonimides, lithium bis(oxalate borate), lithium tris(trifluoromethylsulfonylimide) methide, lithium difluoromethane sulfonate, trifluoromethanesulfonic acid lithium salt (lithium triflate), lithium bis(oxalato) borate, lithium tetrafluoroborate, lithium perchlorate, lithium tetrachloroaluminate, lithium hexafluoroarsenate, lithium hexafluoroantimonate, 4,5-dicyano-2-(trifluoromethyl) imidazolide (LiTDI), LiPF₃ (C₂F₅)₃ (LiFAP), LiBF₃(C₂F₅), lithium chloride, and combinations thereof. For example, the electrolyte may comprise lithium hexafluorophosphate.

In some embodiments or examples, the lithium salt may be dissolved in an organic solvent. The lithium salt may be dissolved in an organic solvent selected from ethers, esters, carbonates, and acetals. In one example, the solvent may be selected from dimethoxyethane, diglyme, triglyme, tetraglyme, ethylene carbonate, propylene carbonate, dimethyl carbonate, tetrahydrofuran, and dioxolane. In some embodiments or examples, the lithium salt may be dissolved in an organic solvent selected from the group comprising ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulfolane, dimethyl sulfoxide, 3-methyl-1,3-oxazolidine-2-one, γ-butyrolactone, 1,2-diethoxymethane, tetrahydrofuran, 2-methyltetrahydrofuran, 1,3-dioxolane, 1,2-dimethoxyethane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, and any combinations thereof. In some embodiments or examples, the lithium salt may be dissolved in an organic solvent selected from the group comprising ethylene carbonate, dimethyl carbonate, diethyl carbonate, and any combinations thereof.

The electrolyte may comprise an additive selected from one or more alkali metal salts of LiPF₆ LiBF₄, LiAsF₆, LiSbF₆, LiClO₄, LiAlCl₄, LiGaCl₄, LIC(SO₂CF₃)₃, LIN(SO₂CF₃)₂, LiSCN, LiSO₂CF₂CF₃, LiC₆F₅SO₃, LIO₂CCF₃, LiSO₃F, LiB(C₆H₅)₄, LiCF₃SO₃, LiNO₃, and mixtures thereof. In other embodiments, the additive may be selected from one or more of flouroethylene carbonate (FEC), vinylethylene carbonate (VEC), vinyl carbonate (VC), propylene carbonate (PC), ethylmethyl carbonate (EMC), propane sultone (PS), and mixtures thereof. Electrolyte additives can further improve certain characteristics of the cell. For example, the electrolyte (e.g. lithium hexafluorophosphate) may comprise an additive (e.g. flouroethylene carbonate) dissolved in an organic solvent (e.g. diethyl carbonate).

In some embodiments or examples, the lithium salt may be dissolved in one or more organic solvents as described above, wherein the one or more organic solvents are present in a volume to volume ratio ranging from 10 to 1 to 1 to 10. For example, the lithium salt (e.g., 1M LiPF₆) may be dissolved in FEC/DEC (2:8) v %, FEC:EMC (3:7) w/w+2 wt. % VC, EC/EMC/DEC (3/5/2 vol %)+1 wt. % VC+10 wt. % FEC, or EC/EMC (3:7) wt. %+1 wt. % VC.

In some embodiments or example, a separator is used to electrically separate the anode from the cathode, and allowing free passage of lithium ions in the electrolyte. The separator may be selected from a range of different porous polymer films. It will be appreciated that any porous polymer film may be selected for use as a separator that have a suitable porosity, tortuosity and thickness. For example, a polymer film-based separator material may be selected. In an embodiment or example, the separator may be selected from a polyethylene (PE), polypropylene (PP), or polyethylene terephthalate (PET). In another embodiment a non-woven fibrous material be selected as the separator, comprising of fibres selected from nylon, polyethylene terephthalate (PET), cellulose, aramid or polyacrylonitrile.

In some embodiments or examples, the electrochemical cell may be an energy storage device. The energy storage device may be a battery. For example, the battery may be a secondary battery. In one particular example, the battery may be a lithium ion battery (Li-ion battery).

### Anode Composition for Lithium-Ion Battery

In some embodiments or examples, the present disclosure also provides a method for improving cycling stability of a battery having an anode and a cathode, at least one electrolyte, and optionally a separator, wherein the anode comprises the anode composition as described herein. It has been found that the anode comprising the anode composition provides a particularly effective anode for use in a battery (e.g. Li-ion battery) capable of maintaining a long-term capacity retention. In some embodiments or examples, the anode inside a battery may have a discharge capacity of at least about 800 mAh/g for at least 100 cycles of the battery. In some embodiments or examples, the specific capacity (mAh/g) may be at least about 500, 600, 800, 1000, 1200, 1400, 1600, 1800, 2000, 2200, 2400, 2600, 2800, 3000 or 3500. In some embodiments or examples, the specific capacity (mAh/g) may be less than about 3500, 3400, 3200, 3000, 2800, 2600, 2400, 2200, 2000, 1800, 1600, 1400, 1200, 1000, 800, 600 or 500. The specific capacity (mAh/g) may be in a range provided by any two of these upper and/or lower values. In some embodiments or examples, the number of cycles may be at least 80, 100, 120, 140, 160, 180, 200, 220, 240, 260, 280, 300, 320, 340, 360, 380, 400, 420, 440, 460, 480, 500, 1000 or 1500.

The long term cyclic performance of an electrochemical cell (e.g. Li-ion battery) comprising the anode composition may be tested for high silicon content anodes (i.e. about 70% silicon content) with varying capacity limitation. The initial discharge capacity of the anode comprising the anode composition, according to at least some embodiments or examples as described herein, can be at least about (in mAh/g) 600, 800, 1100, 1200, 1300, 1400, 1500, or 1600. At least according to some embodiments or examples, 80% of the discharge capacity may be retained after cycles of 100, 200, 300, 400, 500, 800, 1000 or 1500.

It will be appreciated that galvanostatic charge-discharge cycling experiments may typically be used to evaluate the performance metrics of a battery: capacity, rate capability, coulombic efficiency, and capacity retention upon cycling.

In some embodiments or examples, the present disclosure is also directed to a use of the anode comprising an anode composition, as described herein, in an electrochemical cell. For example, the electrochemical cell may be an energy storage device, such as a battery, preferably a secondary battery. More particularly, the battery may be a lithium-ion battery.

In some embodiments or examples, the present disclosure is also directed to an anode comprising an anode composition, wherein the anode may be a battery anode. More particularly, a lithium ion battery anode.

It has been found that the optionally coated anode composition, which may comprise or consist of optionally coated micro silicon active material particles, optionally one or more binders, optionally one or more conductive materials, and optionally one or more additives, significantly reduces effects shown by SEI formation and silicon expansion and degradation, and therefore provides improved performance of Li-ion batteries. The anode composition, provides a high first cycle efficiency, and further advantages providing controlled silicon utilization, which, in turn, improves the high current response and performance of the battery. For example, an electrochemical cell (e.g., Li-ion battery) comprising the anode composition as described herein, allows partially utilization/lithiation of silicon and the specific capacity of the anode is reduced and controlled by the amount of lithium the cathode is able to supply, providing an improved average Coulombic efficiency (CE) of at least about 75, 80, 85, 90, 95, 98%, 99%, 99.5%, 99.8%, 99.9% or higher or less than 100% over at least 200 cycles. In another example, use of the anode composition as an anode, provides improved performance of Li-ion batteries showing cyclic stability after at least 200 cycles at C/2.

Further, it has been surprisingly found that if the N/P ratio for an anode that contains majority micro-silicon (e.g., >70%) is manipulated to a value of above 3 (e.g., 3.3), stable cycling of the anode can be provided to achieve more than 200 cycles at greater than 80% capacity retention. In other words, the high N/P ratio limits the degree of lithiation of the micro-silicon, as the amount of Li⁺ is fixed by the cathode upon cell assembly. This leads to a degree of silicon lithiation of about 20% to about 80%, instead of 80% to 90% as seen for the conventional cell assembly where the anode comprises majority graphite, which has a stabilizing effect on the cells performance. It will be understood that the anode is significantly oversized relative to the amount lithium that is contained in the cell and provided by the cathode. Advantageously, as the degree of lithiation is limited by the oversized anode so is the level of expansion of the silicon and its degradation.

### Preparation Process

In some embodiments or examples, the present disclosure is directed to a process for preparing an anode for an electrochemical cell. The process will include at least one of incorporating coated micro silicon active material particles into the anode or coating the anode itself either during or following its formation. The process may be for preparing an anode according to any embodiments or examples as described herein. It will be appreciated that the anode prepared by the process may comprise an anode composition comprising micro silicon active material particles or coated micro silicon active material particles. It will be appreciated that the anode prepared by the process may comprise or consist an anode composition comprising micro silicon active material particles, optionally one or more further active materials, optionally one or more binders, optionally one or more conductive materials, optionally one or more additives, and optionally a solvent. It will also be appreciated that the anode prepared by the process may comprise or consist an anode composition comprising coated micro silicon active material particles, optionally one or more further active materials, optionally one or more binders, optionally one or more conductive materials, optionally one or more additives, and optionally a solvent. The micro silicon active material particles, coated micro silicon active material particles, one or more further active materials, one or more optional binder, one or more optional conductive materials, one or more optional additives, and one or more optional solvents may be selected from any one or more of the embodiments or examples as described herein.

In some embodiments or examples, there is provided a process for preparing a coated micro silicon active material particle, comprising: (i) providing a plurality of micro silicon active material particles, wherein the micro silicon active material particles have one or more of the following: (i) a measured BET surface area between about 0.1 m²/g and about 10 m²/g. (ii) a D₅₀ particle size between about 0.1 μm and about 10 μm, and (iii) a ratio of D₅₀:BET surface area between about 0.1 to about 10; and (ii) applying a coating onto the surface of the micro silicon active material particles.

In some embodiments or examples, there is provided a process for preparing a coated micro silicon active material particle, comprising: (i) providing a plurality of micro silicon active material particles, wherein the micro silicon active material particles have (i) a measured BET surface area between about 0.1 m²/g and about 10 m²/g and (ii) a D₅₀ particle size between about 0.1 μm and about 10 μm, or (iii) a ratio of D₅₀:BET surface area between about 0.1 to about 10; and (ii) applying a coating onto the surface of the micro silicon active material particles.

In some embodiments, or examples, there is provided a process for preparing of an anode for an electrochemical cell, comprising the steps of: (i) preparing an anode slurry comprising micro silicon active material particles or coated micro silicon active material particles, optionally one or more further active materials, optionally one or more binders, optionally one or more conductive materials, optionally one or more additives, and a solvent system; (ii) casting a layer of the anode slurry onto a current collector material to provide a anode composition layer on the current collector material; and (iii) optionally coating the anode composition, wherein the micro silicon active material particles have one or more of the following: (a) a measured BET surface area between about 0.1 m²/g and about 10 m²/g. (b) a D₅₀ particle size between about 0.1 μm and about 10 μm, and (c) a ratio of D₅₀:BET surface area between about 0.1 to about 10.

In some embodiments, or examples, there is provided a process for preparing of an anode for an electrochemical cell, comprising the steps of: (i) preparing an anode slurry comprising micro silicon active material particles or coated micro silicon active material particles, optionally one or more further active materials, optionally one or more binders, optionally one or more conductive materials, optionally one or more additives, and a solvent system; (ii) casting a layer of the anode slurry onto a current collector material to provide a anode composition layer on the current collector material; and (iii) optionally coating the anode composition, wherein the micro silicon active material particles have (a) a measured BET surface area between about 0.1 m²/g and about 10 m²/g and (b) a D₅₀ particle size between about 0.1 μm and about 10 μm or (c) a ratio of D₅₀:BET surface area between about 0.1 to about 10.

In some embodiments or examples, the process may further comprise step (iii) solidifying the wet anode layer by solvent evaporation to provide a dry anode composition layer on the current collector material.

In some embodiments or examples, the coating may be selected from the group comprising carbon, graphene, graphite, metal oxide, polymer, and combinations thereof, to form a coated micro silicon active material particle or a coated anode composition.

In some embodiments or examples, the coating may be a coating of the micro silicon active material particles. In other embodiments or examples, the coating may be a coating of the anode composition. In other words, the coating may be present on at least a portion of the surface of the anode composition.

In some embodiments, the coating may be selected from the group comprising carbon, graphene, graphite, metal oxide, polymer, and combinations thereof, to form a coated micro silicon active material particle or a coated anode composition.

The coatings may be from the materials and made by the approaches as described in any of the aforementioned embodiments relating to the coatings of the disclosure and/or the silicon particles of the disclosure with the coatings so applied.

In some embodiments or examples, the solvent may be an organic solvent selected from aromatics, halogenated aromatics, halogenated aliphatic hydrocarbons, aliphatic hydrocarbons, glycols, ethers, glycol ethers, esters, alcohols, ketones, or combinations thereof. In some embodiments or examples, the solvent may be present in an amount (by weight % of total anode composition) between about 40 wt. % and 90 wt. %, between about 40 wt. % and 70 wt. %, or between about 40 wt. % and 60 wt. %. The solvent may be a low boiling point organic solvent, or a mixture of one or more of such solvents. In some embodiments or examples, the solvent may be selected from the group comprising water, methanol, ethanol, n-propanol, isopropanol, tetrahydrofuran, methylene chloride, chloroform, diethyl ether, room temperature ionic liquids, ethylene glycol, glycerol, formamide, N-methylformamide, dimethylformamide, N-methylsydnone, an aqueous solution thereof, and any mixtures thereof. For example, the solvent may be water, ethanol, N,N′dimethylformamide, or a combination thereof.

In some embodiments or examples, the ratio of binder to micro silicon active material particles may be about 1:40, 1:35, 1:32, 1:30, 1:25, 1:23, 1:20, 1:15, 1:10, 1:9, 1:6, or 1:4. The ratio of binder to micro silicon active material particles or coated micro silicon active material particles may be in a range of about 1:4 to about 1:32. The ratio of binder to micro silicon active material particles or coated micro silicon active material particles may be in a range of about 1:8 to about 1:23. The ratio of binder to micro silicon active material particles or coated micro silicon active material particles may be in a range of about 1:9 to about 1:15.

In some embodiments or examples, the binder (in wt. %) may be present in the anode composition in a range of about 2.5 to 15. The binder (wt. %) may be present in the anode composition in an amount of less than about 15, 12, 10, 8, 5 or 2.5. The binder (in wt. %) may be present in the anode composition in an amount of at least about 2.5%, 5%, 8%, 10%, 12%, or 15%. The binder (in wt. %) may be present in the anode composition in a range provided by any two of these upper and/or lower amounts. For example, the binder (in wt. %) may be present in the anode composition in a range of about 3 to about 8, or about 4 to about 8.

In some embodiments or examples, the viscosity of the anode slurry may be in a range between about 10 mPas and 100,000 mPas. The viscosity (mPas) may be less than about 100,000, 90,000, 80,000, 70,000, 60,000, 50,000, 40,000, 30,000, 20,000, 10,000, 8000, 6000, 4000, 2000, 1000, 800, 600, 400, 200, 100, 50, or 10 at a given shear rate. The viscosity may be at least about 10, 20, 40, 60, 80, 100, 300, 500, 700, 900, 1000, 3000, 5000, 7000, 9000, 10,000, 20,000, 30,000, 40,000, 50,000, 60,000, 70,000, 80,000, 90,000, or 100,000 at a given shear rate. The viscosity (mPas) of the anode slurry may be in a range provided by any two of these upper and/or lower amounts. For example, viscosity (mPas) of the anode slurry may be in a range of about 2500 mPas to about 8000 mPas at a given shear rate. All viscosity values recited herein may be at a given shear rate. In embodiments the shear rate may be that as used in any accepted standard testing approach in the art.

In some embodiments or examples, the thickness of the dry anode composition may be substantially uniform and in the range of about 5 μm to about 70 μm. The thickness (μm) of the dry anode composition may be less than about 70, 65, 60, 55, 50, 45, 40, 35, 30, 25, 20, 15, 10, or 5. The thickness (μm) of the dry anode composition may be at least about 5, 10, 15, 20, 25, 30, 35, 40, 45, 50, 55, 60 or 65. The thickness of the dry anode composition may be in a range provided by any two of these upper and/or lower amounts.

In some embodiments or examples, the wet anode composition layer may be maintained at a temperature of between about 40° C. and about 60° C. in step (iii) (a) for about 30 seconds to about 5 minutes. The wet anode composition may be maintained at a temperature (° C.) of less than about 60, 55, 50, 45, or 40. The wet anode composition may be maintained at a temperature (° C.) of at least about 40, 45, 50, 55, or 60. The wet anode composition may be maintained at a temperature (° C.) in a range provided by any two of these upper and/or lower values. The wet anode composition may be maintained at a temperature as described herein for less than about 24 hours, 12 hours, 8 hours, 4 hours, 2 hours, 1 hours, 30 minutes, 5 minutes, 4 minutes, 3 minutes, 2 minutes, 1 minute, or 30 seconds. The wet anode composition may be maintained at a temperature as described herein for at least about 30 seconds, 1 minute, 2 minutes, 3 minutes, 4 minutes, 5 minutes, 30 minutes, 1 hour, 2 hours, 4 hours, 10 hours, 12 hours, or 24 hours. The wet anode composition may be maintained at a temperature as described herein for a time in a range provided by any two of these upper and/or lower values.

In some embodiments or examples, the wet anode composition may be maintained at a temperature of between about 90° C. and about 180° C. in step (iii) (b) for about 30 seconds to about 5 minutes. The wet anode composition may be maintained at a temperature (° C.) of less than about 180, 170, 160, 150, 140, 130, 120, 115, 110, 105, 100, 95 or 90. The wet anode composition may be maintained at a temperature (° C.) of at least about 90, 95, 100, 105, 110, 115, 120, 130, 140, 150, 160, or 170. The wet anode composition may be maintained at a temperature (° C.) in a range provided by any two of these upper and/or lower values. The wet anode composition may be maintained at a temperature as described herein for less than about 24 hours, 12 hours, 8 hours, 4 hours, 2 hours, 1 hours, 30 minutes, 5 minutes, 4 minutes, 3 minutes, 2 minutes, 1 minute, or 30 seconds. The wet anode composition may be maintained at a temperature as described herein for at least about 30 seconds, 1 minute, 2 minutes, 3 minutes, 4 minutes, 5 minutes, 30 minutes, 1 hour, 2 hours, 4 hours, 10 hours, 12 hours, or 24 hours. The wet anode composition may be maintained at a temperature as described herein for a time in a range provided by any two of these upper and/or lower values.

In some embodiments or examples, the anode slurry can be made homogeneous to provide further advantages/improvements.

In some embodiments or examples, the present disclosure is directed to a process for assembling an electrochemical cell, whereby the process may comprise the steps of: preparing an anode as defined by the process at least according to any one of the examples described herein, wherein the anode may comprise an anode composition comprising micro silicon active material particles; and assembling the anode into an electrochemical cell. In some other embodiments or examples, the present disclosure is directed to a process for assembling an electrochemical cell, whereby the process may comprise the steps of: preparing an anode as defined by the process at least according to any one of the examples described herein, wherein the anode may comprise or consist of an anode composition comprising micro silicon active material particles or coated micro silicon active material particles, optionally one or more further active materials, optionally one or more binders, and optionally one or more conductive materials, at least according to any one of the examples described herein; and assembling the anode into an electrochemical cell.

Upon formation of the anode slurry, some or all of the solvent may be removed (e.g., by natural evaporation, forced evaporation, or under vacuum) to generate a solid or viscous anode slurry. The anode slurry may be formed or moulded in any desired shape, such as an anode.

In some embodiments or examples, the anode slurry may also be deposited on a current collector material, as defined herein, to generate an anode. It will be appreciated that the anode is the combination of the current collector material and the anode composition, also referred to as an anode composition applied to a current collector material. The current collector material can be selected from any current collector material referred to herein.

During preparation of an anode, the anode composition may be applied to only a portion of the surface of the current collector material. In some embodiments or examples, the portion (%) may be less than about 100, 95, 90, 85, 80, 75, 70, 65, 60, 55, 50, 45, 40, 35, 30, 25, 20, 15, 10, or 5. In some embodiments or examples, the anode composition may be applied by casting on the current collector material (e.g. roll-to-roll processing).

The coating can be prepared by dissolving or dispersing the coating in an appropriate solvent and then mixing them together, optionally with one or more agents or dissolving the coating into a suitable solvent under suitable processing conditions.

The coating may be applied in different physical forms such as a solution, dispersion, suspension, mixture, aerosol, emulsion, paste or combination thereof.

In one example, a process for preparing a coated anode comprises:
a. applying a coating as described herein to an anode composition; and
b. optionally applying one or more post coating layers to the coating present on the anode composition.

In some embodiments, the coated anode composition may be provided from pyrolization of a coating or by chemical vapour deposition, physical vapour deposition, sputtering, or mechanical deposition.

In some embodiments or examples, the coating may be in the form of a single layer. In another embodiment, the coating may be in the form of two or more layers, for example, a plurality of layers. The coating may comprise between about 1 to 5 layers. The coating may comprise less than 5 layers, 4 layers, 3 layers, or less than 2 layers. The coating may comprise at least about 1 layer, 2 layers, 3 layers, 4 layers, or at least about 5 layers. The coating may comprise layers in a range provided by any lower and/or upper limit as previously described. It will be appreciated that each layer may be provided by a different coating. For example, the coated micro silicon active material particles or coated anode composition may comprise a coating, wherein one coating layer comprises a carbon material another coating layer comprises a metal oxide (e.g., aluminium oxide) and another layer comprises a polymeric coating, applied in any order to the micro silicon. Alternatively, the coating may be a carbon material coating and a metal oxide coating, applied in either order to the micro silicon. Further, the coating may be a carbon material coating and a polymeric coating, applied in either order to the micro silicon.

In some embodiments or examples, the thickness of the coating may be between about 0.1 nm and about 200 nm, or between about 0.2 nm and about 150 nm, or between about 0.3 nm and about 100 nm, or between about 0.3 nm and about 75 nm, or between about 0.3 nm and about 50 nm, or between about 0.3 nm and about 25 nm, or between about 0.3 nm and about 20 nm, or between about 0.3 nm and about 10 nm. The thickness of the coating (in nm) may be less than about 200, 175, 150, 125, 100, 90, 80, 75, 70, 65, 60, 55, 50, 45, 40, 35, 30, 25, 20, 15, 10, 8, 6, 5, 4, 3, 2, 1, 0.9, 0.8, 0.7, 0.6, 0.5, 0.4, 0.3, 0.2, or 0.1. The thickness of the coating (in nm) may be at least about 0.1, 0.2, 0.3, 0.4, 0.5, 0.6, 0.7, 0.8, 0.9, 1, 2, 3, 4, 5, 6, 7, 8, 9, 10, 12, 14, 16, 18, 20, 25, 30, 35, 40, 45, 50, 55, 60, 65, 70, 75, or 80. The thickness of the coating (in nm) may be in a range provided by any two of these upper and/or lower amounts.

In some embodiments, the ratio of the coating thickness to uncoated silicon particle diameter (t/d as X: 1) may be between about 0.0001:1 to about 0.2:1, or between about 0.0001:1 to about 0.15:1, or between about 0.0001:1 to about 0.12:1, or between about 0.0001:1 to about 0.1:1, or between about 0.0001:1 to about 0.09:1, or between about 0.0001:1 to about 0.085:1. Viewed another way, in some embodiments, the ratio of the silicon particle diameter to coating thickness (d/t as 1:X) may be between about 1:100,000 to about 1:5, or between about 1:100,000 to about 1:8, or between about 1:100,000 to about 1:10, or between about 1:100,000 to about 1:12.

It is believed that the coatings on the micro silicon active material particles or the anode composition, as described herein, can improve cycling stability and reduce electrolyte decomposition due to electrochemical protection of the anode surface. It will be appreciated that the coating may provide the micro silicon active particles or anode composition with a number of properties including, for example, structural strength, lower surface area, reduced pulverization, electron conductivity, Li-ion conductivity, passivation and/or insulation, and ultimately improve silicon anode capacity retention.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### EXAMPLES

The present disclosure is further described by the following examples. It is to be understood that the following description is for the purpose of describing particular examples only and is not intended to be limiting with respect to the above description.

### Example 1: General Procedure for Preparing Anodes

To prepare the anode slurry, a binder solution and a conductive material are combined using a planetary-centrifugal mixer. The mixture is then incorporated at 2000 rpm for 2 minutes, manually mixed with a spatula, and then mixed for another 2 minutes. The micro silicon active material particles and required amounts of additional water are added and the mixing steps are repeated. An active graphite is added, and the mixing steps are repeated. Unless otherwise mentioned a pre-determined amount of anode slurry is transferred to a Dispermat-compatible container and is mixed at 6000 rpm using an overhead mixer (e.g.: VMA-Getzmann Dispermat) for 5 minutes.

In a full cell assembly, the slurries were cast onto copper foil and dried at 60° C. then cut for coin cell assembly. The electrodes (coated anodes and commercially supplied NCM 523 cathodes) were further dried under vacuum for 12 h at 110° C. 150 μL of 1M LiPF₆ in FEC/DEC (2:8) vol. % was used as the electrolyte and Whatman fiberglass as the separator for the coin cell (CR 20232 type) assembly. For charge/discharge cycling tests, the coin cells were activated at 0.05 C for 1 cycle and then cycled at 0.5 C for long-term stability testing. The C rates were based on the mass of active material (Si particles, graphite) in the electrodes. The voltage range for charge/discharge tests was 4.2-2.5V during formation and 4.2-3V during cycling. The charge/discharge tests were conducted on Neware multi-channel battery testers controlled by a computer. Four replicate cells were made and tested for each condition.

TABLE 1
Formation test-program of full cell

| | | Cut-off | |
|---|---|---|---|
| Name | Rate | (V) | Notes |
| Rest | | | 1 h |
| Tap charge | C/3 | 3 | |
| Rest | | | 12 h |
| Constant current | C/20 | 4.2 | Cut-off current (C/100) |
| constant voltage charge | | | |
| Constant current discharge | C/20 | 2.5 | |
| End Cycle | | | |

Note the current density used for cycling tests is based on the electrode capacity obtained for the last delithiation step of the formation program.

TABLE 2
Cycling test-program of full cell

| | | Cut-off | |
|---|---|---|---|
| Name | Rate | (V) | Notes |
| Constant current | C/2 | 4.2 | Cut-off current (C/20) |
| constant voltage charge | | | |
| Constant current discharge | C/2 | 3 | |
| Repeat from step 1 | | | Repeat until cell fails |
| | | | or <80% capacity |
| End Cycle | | | |

It will be appreciated that the thickness of the coating that is applied to a micro-silicon particle can be estimated if the surface area of the particle before coating, the weight the coating contributes to the micro-silicon particle powder and the density of the respective coating material are known. The following generic formula is used to estimate the coating thickness of the coatings that were applied to the micro-silicon particles disclosed in any of the following examples, and in all discussion of coating thickness within the present disclosure, where the true density of the coating material is used as an approximation for the resulting coating density:

Calculated coating thickness on micro-silicon particle=(Weight added by the coating material to the micro-silicon particle/True density of the coating material)/Surface of the uncoated micro-silicon particle.

It will be appreciated that the true coating thickness on the micro-silicon particle may be slightly higher or lower, subject to the properties and actual density of the coating, which will change depending on the coating material and the method of application.

### Example 2: Al₂O₃ Coated Micro-Silicon

The D₅₀ particle size and BET surface area values for the uncoated and Al₂O₃ coated micro-silicon are as follows.

TABLE 3
Particle size and surface area properties

| | | Calculated | | BET |
|---|---|---|---|---|
| | PSD | coating | Calculated coating | surface |
| Si | (D50, | thickness | thickness (μm):uncoated | area |
| material | μm) | (nm) | Si PSD D50 (μm) ratio | (m²/g) |
| Uncoated | 4.79 | — | — | 1.53 |
| 0.2 wt % | 4.45 | 0.33 | 0.000069 | 2.33 |
| Al₂O₃ | | | | |
| 0.3 wt % | 4.39 | 0.50 | 0.000104 | 3.04 |
| Al₂O₃ | | | | |
| 0.6 wt % | 5.01 | 0.99 | 0.000207 | 3.89 |
| Al₂O₃ | | | | |

### Example 2 (a) Electrode Composition

An anode composition comprising uncoated or Al₂O₃ coated micro-silicon was fabricated. The specific electrode and slurry composition used for all the experiments are shown in Table 4 below.

TABLE 4
Electrode and slurry composition

| | | | Conductive filler | | | | Binder (PAA, | | |
|---|---|---|---|---|---|---|---|---|---|
| | Active | | (Timrex KS6L | | Conductive aid | | 25% neutralized | | |
| | material (Si) | | flaked graphite) | | (Timcal Super C65) | | with LiOH) | | H₂O |
| | | Mass | | Mass | | Mass | | Mass | Mass |
| Si material | wt % | (g) | wt % | (g) | wt % | (g) | wt % | (g) | (g) |
| Uncoated | 70 | 24.5 | 20 | 7.00 | 2 | 0.7 | 8 | 2.8 | 29.8 |
| 0.2 wt % Al₂O₃ | 70.20 | 31.94 | 19.80 | 9.01 | 2 | 0.91 | 8 | 18.20 | 19.76 |
| 0.3 wt % Al₂O₃ | 70.30 | 31.99 | 19.70 | 8.96 | 2 | 0.91 | 8 | 18.20 | 19.76 |
| 0.6 wt % Al₂O₃ | 70.40 | 32.03 | 19.60 | 8.92 | 2 | 0.91 | 8 | 18.20 | 21.26 |

The slurries were prepared using the compositions in Table 4. The procedure described in Example 1 was used for the preparation process.

### Example 2 (b) Slurry Preparation

The slurries were prepared using the compositions in Table 4. The procedure described in Example 1 was used for the preparation process.

### Example 2 (c) Electrochemical Test Program

The full cells were assembled using the procedure described in Example 1. Please see Table 1 and 2 for the cycling program.

### Example 2 (d) Cycling Test—Summary of Key Findings

TABLE 5
Overview of limited capacity full cell electrochemical data

| | | | | | | Cathode | | Anode | |
|---|---|---|---|---|---|---|---|---|---|
| | Anode | | | | | Discharge | Discharge | Discharge | Discharge |
| | | Specific | Areal capacity | | | Capacity | Capacity | Capacity | Capacity |
| Coated | Thickness | loading | Anode | Cathode | ICE | @C/20 | @C/2 | @C/20 | @C/2 |
| material | μm | mg/cm² | mAh/cm² | mAh/cm² | % | mAh/g | mAh/g | mAh/g | mAh/g |
| Uncoated | 53 | 5.9 | 12.8 | 4.2 | 89.0 | 160 | 132 | 714 | 588 |
| 0.2 wt % | 53.6 | 5.7 | 12.4 | 3.6 | 89.8 | 161 | 132 | 763 | 625 |
| Al₂O₃ | | | | | | | | | |
| 0.3 wt % | 56.3 | 5.8 | 12.5 | 3.6 | 89.8 | 161 | 132 | 761 | 620 |
| Al₂O₃ | | | | | | | | | |
| 0.6 wt % | 55.5 | 5.7 | 12.4 | 3.5 | 89.8 | 162 | 132 | 763 | 622 |
| Al₂O₃ | | | | | | | | | |

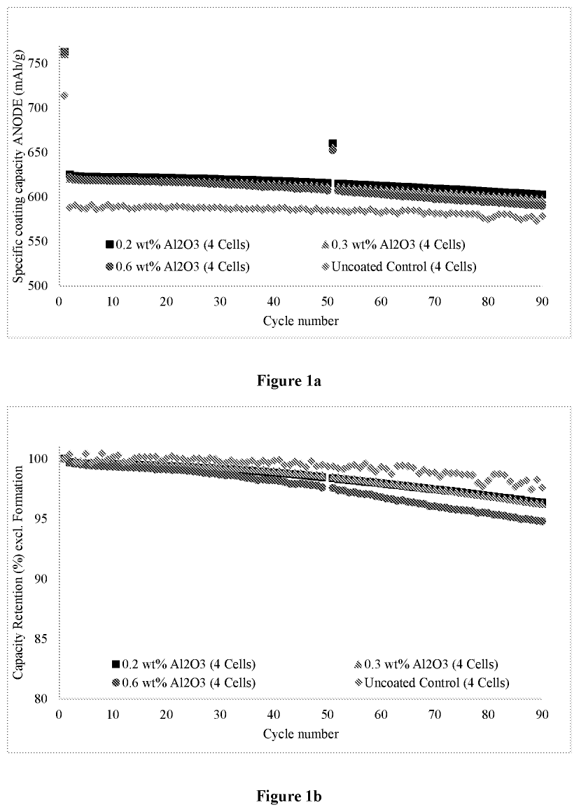

The coating of Al₂O₃ at different ratios showed an equal increase in ICE (0.8%) when compared to uncoated and equal starting capacity (Table 5). At cycle 90 there was no clear difference in the capacity retention (˜96%) between the 0.2 wt % and 0.3 wt % Al₂O₃ coated samples (FIG. 1b) and only 1% difference in capacity retention when compared to the uncoated. Whereas the higher amount of Al₂O₃ (0.6 wt %) showed a fast decrease in capacity retention at cycle 90 and the tested cells lost 6% of its capacity.

### Example 3: Phenolic Resin Precursor Carbon Coated Micro-Silicon

### Example 3(a) Micro-Silicon Particle Coating

### Example 3.1:6.6 wt % Carbon Coated Micro-Silicon

30 g phenolic resin was added into 150 g of absolute ethanol and the solution was mixed until the resin was completely dissolved using a magnetic stirrer at room temperature. Next, 104 g of micro-silicon was added into the ethanol-resin solution, and the suspension was continued to stir for 1 hour. The mixture was then heated at 70° C. for 12 hours until the ethanol had completely evaporated. 61.5 g of resin-coated micro-silicon was transferred to a ceramic crucible and placed in the furnace tube. The furnace was purged with high purity nitrogen gas at a flow rate of 2 L/min for 30 minutes at room temperature prior to starting the calcination process and maintained throughout. The sample was heated to 900° C. at a heating rate of 4° C./min and calcined for 1 hour. The furnace was then allowed to cool down to room temperature while maintaining the nitrogen gas flow at least until the furnace temperature reached 100° C. The calcined micro-silicon sample was ground using a mortar and pestle for approximately 5 minutes to break down any larger chunks of silicon. The product was then ball-milled at 6 minutes milling and 3 minutes resting intervals for total of 3 hours at 520 rpm using a milling ratio of 30 wt % silicon and 70 wt % grinding media (i.e., 1 cm diameter ceramic balls).

### Example 3.2:7.93 wt % Carbon Coated Micro-Silicon

The coating procedure in Example 3.1 was repeated using 40 g of phenolic resin and 104 g of micro-silicon. 65 g of resin-coated micro-silicon was transferred to a ceramic crucible and placed in the furnace tube. The furnace was purged with high purity nitrogen gas at a flow rate of 2 L/min for 30 minutes at room temperature prior to starting the calcination process and maintained throughout. The sample was heated to 900° C. at a heating rate of 4° C./min and calcined for 2 hours. The furnace was then allowed to cool down to room temperature while maintaining the nitrogen gas flow at least until the furnace temperature reached 100° C. The calcined micro-silicon sample was ground using a mortar and pestle for approximately 5 minutes to break down any larger chunks of silicon. The product was then ball-milled at 6 minutes milling and 3 minutes resting intervals for total of 3 hours at 520 rpm using a milling ratio of 30 wt % silicon and 70 wt % grinding media (i.e., 1 cm diameter ceramic balls).

The D₅₀ particle size and BET surface area values for the carbon coated micro-silicon are as follows.

TABLE 6
Particle size and surface area properties

| | | Calculated | | BET |
|---|---|---|---|---|
| | PSD | coating | Calculated coating | surface |
| Si | (D50, | thickness | thickness (μm):uncoated | area |
| material | μm) | (nm) | Si PSD D50 (μm) ratio | (m²/g) |
| 6.6 wt % | 3.17 | 19.43 | 0.004057 | 66.51 |
| PR (C) | | | | |
| 7.93 wt % | 2.82 | 23.35 | 0.004874 | 86.99 |
| PR (C) | | | | |

### Example 3 (b) Electrode Composition

An anode composition consisting of carbon coated micro-silicon was fabricated. The specific slurry and electrode composition used for all experiments are shown in Table 7 below.

TABLE 7
Electrode composition

| | | | Conductive filler | | | | Binder (PAA, | | |
|---|---|---|---|---|---|---|---|---|---|
| | Active | | (Timrex KS6L | | Conductive aid | | 25% neutralized | | |
| | material (Si) | | flaked graphite) | | (Timcal Super C65) | | with LiOH) | | H₂O |
| Example | wt % | Mass (g) | wt % | Mass (g) | wt % | Mass (g) | wt % | Mass (g) | Mass (g) |
| 6.6 wt % | 75.20 | 34.22 | 14.80 | 6.73 | 2 | 0.91 | 8 | 18.20 | 19.76 |
| PR (C) | | | | | | | | | |
| 7.93 wt % | 76.30 | 34.72 | 13.70 | 6.23 | 2 | 0.91 | 8 | 18.20 | 19.76 |
| PR (C) | | | | | | | | | |

### Example 3 (c) Slurry Preparation

Material quantities specified in Table 7 were used for the slurry preparation process. The same procedure as in Example 1 was followed.

### Example 3 (d) Electrochemical Test Program

The full cells were assembled using the procedure described in Example 1. Please see Table 1 and 2 for the cycling program.

### Example 3 (e) Cycling Test—Summary of Key Findings

TABLE 8
Overview of limited capacity full cell electrochemical data

| | | | | | | Cathode | | Anode | |
|---|---|---|---|---|---|---|---|---|---|
| | Anode | | | | | Discharge | Discharge | Discharge | Discharge |
| | | Specific | Areal capacity | | | Capacity | Capacity | Capacity | Capacity |
| Coated | Thickness | loading | Anode | Cathode | ICE | @C/20 | @C/2 | @C/20 | @C/2 |
| material | μm | mg/cm² | mAh/cm² | mAh/cm² | % | mAh/g | mAh/g | mAh/g | mAh/g |
| Uncoated | 53 | 5.9 | 12.8 | 4.2 | 89.0 | 160 | 132 | 714 | 588 |
| 6.6 wt % | 53.3 | 5.8 | 12.5 | 3.6 | 86.6 | 156 | 126 | 734 | 592 |
| PR (C) | | | | | | | | | |
| 7.93 wt % | 50.5 | 5.6 | 12.0 | 3.5 | 85.3 | 154 | 124 | 735 | 593 |
| PR (C) | | | | | | | | | |

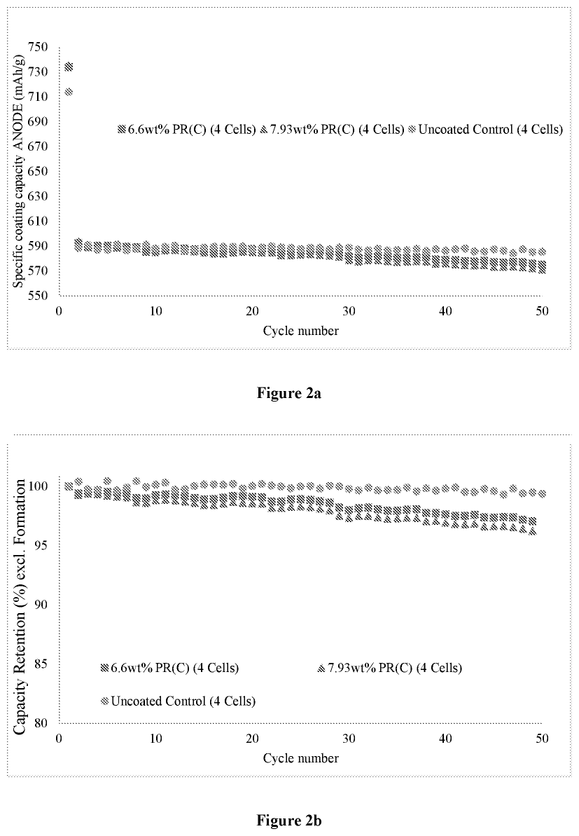

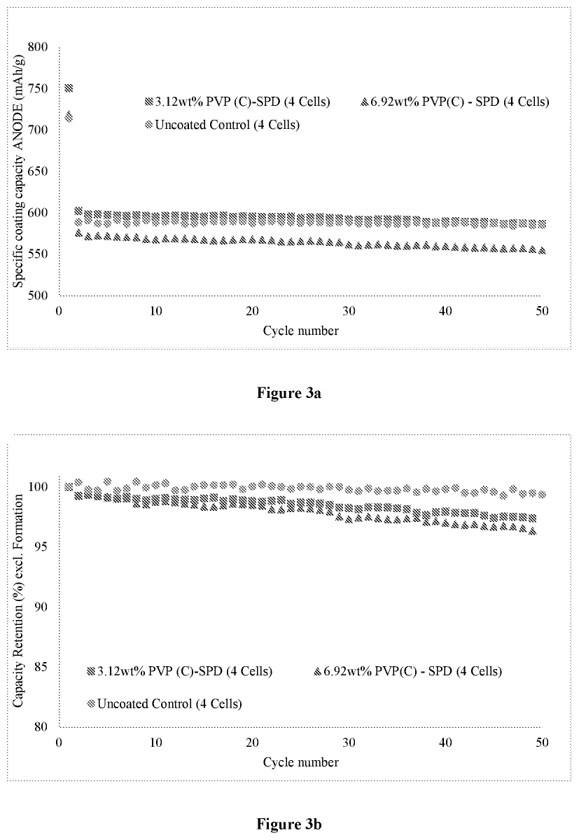

Table 8 shows that increasing the content of phenolic resin (PR) in the coating effected the ICE. The ˜ 8 wt % PR coating showed a 3.7% decrease in the ICE and a decrease of 2.4% for the ˜ 6.6 wt. % PR coating when compared to control. At cycle 50, the capacity retention for the uncoated was 99.4% whereas for the ˜ 8 wt % PR coated cells capacity retention was 96.2% and for ˜ 6.6 wt. % PR was 97% (FIG. 2b).

### Example 4: PVP Precursor Carbon Coated Micro-Silicon

### Example 4 (a) Micro-Silicon Particle Coating

### Example 4.1-6.03 wt % Carbon Coated Micro-Silicon

22.5 g PVP (55,000 M.W.) was added into 250 ml of absolute ethanol and the solution was mixed until the polymer was completely dissolved using a magnetic stirrer at 40° C. Next, 22.5 g of micro-silicon was added into the ethanol-PVP solution, and the suspension was continued to stir. An additional 30 ml of absolute ethanol was added into the mixture to facilitate homogeneous dispersion of the constituents. Next, the mixture was dried at 40° C. for 12 hours under ambient conditions followed by a further drying step at 40° C. for 3 hours under vacuum. 31.6 g of PVP-coated micro-silicon was transferred to a ceramic crucible and placed in the furnace tube. The furnace was purged with high purity nitrogen gas at a flow rate of 2 L/min for 30 minutes at room temperature prior to starting the calcination process and maintained throughout. The sample was heated to 700° C. at a heating rate of 4° C./min and calcined for 2 hours. The furnace was then allowed to cool down to room temperature while maintaining the nitrogen gas flow at least until the furnace temperature reached 100° C. The calcined micro-silicon sample was ground using a mortar and pestle to break down any larger chunks of silicon. The product was then ball-milled at 6 minutes milling and 3 minutes resting intervals for total of 3 hours at 520 rpm using a milling ratio of 30 wt % silicon and 70 wt % grinding media (i.e., 0.7 cm diameter ceramic balls).

### Example 4.2-3.12 wt % Carbon Coated Micro-Silicon

45 g PVP (55,000 M.W.) was added into a mixture of 3 L of deionised water and 5 ml of absolute ethanol. The solution was mixed until the polymer was completely dissolved using a magnetic stirrer at room temperature. Next, 90.0 g of micro-silicon was added into the PVP solution, and the suspension was continued to stir. This suspension was further sonicated for 30 minutes to facilitate the uniform dispersion of micro-silicon powder. The prepared 5 wt % suspension was then spray-dried using a Mini Spray Dryer B-290 (BÜCHI) at 220° C. inlet temperature, 30 L/min air flow, 100% aspiration and 40% solution feed rate. 37.0 g of PVP-coated micro-silicon was transferred to a ceramic crucible and placed in the furnace tube. The furnace was purged with high purity nitrogen gas at a flow rate of 2 L/min for 30 minutes at room temperature prior to starting the calcination process and maintained throughout. The sample was heated to 700° C. at a heating rate of 4° C./min and calcined for 1 hour. The furnace was then allowed to cool down to room temperature while maintaining the nitrogen gas flow at least until the furnace temperature reached 100° C. The coated micro-silicon sample was first ground using a mortar and pestle to break down larger chunks of silicon followed by a laboratory sample mill for 30 minutes.

### Example 4.3-6.92 wt % Carbon Coated Micro-Silicon

90 g PVP (55,000 M.W.) was added into 6 L of deionised water and the solution was mixed using a magnetic stirrer at 30° C. until the polymer was completely dissolved. Next. 91.0 g of micro-silicon was added into the PVP solution that was cooled down to room temperature, and the stirring continued. This suspension was further sonicated for 30 minutes to facilitate the uniform dispersion of micro-silicon powder. The prepared 3 wt % suspension was then spray-dried using a Mini Spray Dryer B-290 (BÜCHI) at 220° C. inlet temperature, 30 L/min air flow, 100% aspiration and 40% solution feed rate. 27.0 g of PVP-coated micro-silicon was transferred to a ceramic crucible and placed in the furnace tube. The furnace was purged with high purity nitrogen gas at a flow rate of 2 L/min for 30 minutes at room temperature prior to starting the calcination process and maintained throughout. The sample was heated to 700° C. at a heating rate of 4° C./min and calcined for 2 hours. The furnace was then allowed to cool down to room temperature while maintaining the nitrogen gas flow at least until the furnace temperature reached 100° C. The calcined micro-silicon sample was ground using a mortar and pestle to break down any larger chunks of silicon. The product was then ball-milled at 6 minutes milling and 3 minutes resting intervals for total of 3 hours at 520 rpm using a milling ratio of 30 wt % silicon and 70 wt % grinding media (i.e., 0.7 cm diameter ceramic balls).

The D₅₀ particle size and BET surface area values for the carbon coated micro-silicon are as follows.

TABLE 9
Particle size and surface area properties

| | | Calculated | | BET |
|---|---|---|---|---|
| | PSD | coating | Calculated coating | surface |
| Si | (D50, | thickness | thickness (μm):uncoated | area |
| material | μm) | (nm) | Si PSD D50 (μm) ratio | (m²/g) |
| 6.03 wt % | 3.22 | 17.75 | 0.003706 | 34.55 |
| PVP (C) | | | | |
| 3.12 wt % | 4.18 | 9.19 | 0.001918 | 14.95 |
| PVP (C) | | | | |
| 6.92 wt % | 3.18 | 20.37 | 0.004253 | 35.28 |
| PVP(C) | | | | |

### Example 4 (b) Electrode Composition

An anode composition consisting of carbon coated micro-silicon was fabricated. The specific electrode composition used for all experiments is shown in Table 10 below.

TABLE 10
Electrode composition

| | | | Conductive filler | | | | Binder (PAA, | | |
|---|---|---|---|---|---|---|---|---|---|
| | Active | | (Timrex KS6L | | Conductive aid | | 25% neutralized | | |
| | material (Si) | | flaked graphite) | | (Timcal Super C65) | | with LiOH) | | H₂O |
| Example | wt % | Mass (g) | wt % | Mass (g) | wt % | Mass (g) | wt % | Mass (g) | Mass (g) |
| 3.12 wt % | 75.30 | 34.26 | 14.70 | 6.69 | 2 | 0.91 | 8 | 18.20 | 19.76 |
| PVP (C) | | | | | | | | | |
| 6.92 wt % | 75.40 | 34.31 | 14.60 | 6.64 | 2 | 0.91 | 8 | 18.20 | 19.76 |
| PVP(C) | | | | | | | | | |

### Example 4 (c) Slurry Preparation

Material quantities specified in Table 10 were used for the slurry preparation process. The same procedure as in Example 1 was followed.

### Example 4 (d) Electrochemical Test Program

The full cells were assembled using the procedure described in Example 1. Please see Table 1 and 2 for the cycling program.

### Example 4 (e) Cycling Test—Summary of Key Findings

TABLE 11
Overview of limited capacity full cell electrochemical data

| | | | | | | Cathode | | Anode | |
|---|---|---|---|---|---|---|---|---|---|
| | Anode | | | | | Discharge | Discharge | Discharge | Discharge |
| | | Specific | Areal capacity | | | Capacity | Capacity | Capacity | Capacity |
| Coated | Thickness | loading | Anode | Cathode | ICE | @C/20 | @C/2 | @C/20 | @C/2 |
| material | μm | mg/cm² | mAh/cm² | mAh/cm² | % | mAh/g | mAh/g | mAh/g | mAh/g |
| Uncoated | 53 | 5.9 | 12.8 | 4.2 | 89.0 | 160 | 132 | 714 | 588 |
| 3.12 wt % | 52.9 | 5.7 | 12.2 | 3.5 | 88.4 | 159.6 | 128 | 751 | 602 |
| PVP (C) | | | | | | | | | |
| 6.92 wt % | 53.0 | 5.7 | 12.3 | 3.5 | 86.1 | 155 | 124 | 718 | 576 |
| PVP(C) | | | | | | | | | |

Table 11 showed that increasing the content of PVP coating adversely affects the ICE: 3.12 wt % PVP sample showed a slight decrease in ICE of 0.6% when compared to control, whereas the 6.92 wt % PVP sample had lost ˜3% of ICE. At cycle 100, the uncoated sample lost ˜3% of its capacity whereas the 3.1 wt % PVP has lost 5% at the same cycle.

### Example 5: PAN Precursor Carbon Coated Micro-Silicon

### Example 5 (a)-14.5 wt % Carbon Coated Micro-Silicon

45 g PAN (150,000 MW) was added into 500 ml of DMF while stirring at 70° C. using a shear mixer. After complete dissolution of the polymer, 90.0 g of micro-silicon was added into the polymer solution, and the suspension was continued to mix using the shear mixer. During this process, the solution temperature increased to 120° C. facilitating the evaporation of DMF solvent. After the solution consistency become difficult to mechanically mix, the resultant product was transferred into 3 ceramic crucibles and further dried at either: (i) 200° C. for 2 hours under N₂ gas flow, (ii) 200° C. for 2 hrs at atmospheric conditions or (iii) 110° C. for 2 hours under vacuum. 60 g of the resultant dried product was placed in the furnace tube and the furnace was purged with high purity nitrogen gas at a flow rate of 2 L/min for 30 minutes at room temperature prior to starting the calcination process. The sample was heated to 900° C. at a heating rate of 4° C./min and calcined for 2 hours. The furnace was then allowed to cool down to room temperature while maintaining the nitrogen gas flow at least until the furnace temperature reached 100° C. The calcined micro-silicon sample was ground using a mortar and pestle for approximately 5 minutes to break down any larger chunks of silicon. The product was then ball-milled at 6 minutes milling and 3 minutes resting intervals for total of 3 hours at 520 rpm using a milling ratio of 30 wt % silicon and 70 wt % grinding media (i.e., 0.7 cm diameter ceramic balls).

The D₅₀ particle size and BET surface area values for the carbon coated micro-silicon are as follows.

TABLE 12
Particle size and surface area properties

| | | Calculated | | BET |
|---|---|---|---|---|
| | PSD | coating | Calculated coating | surface |
| Si | (D50, | thickness | thickness (μm):uncoated | area |
| material | μm) | (nm) | Si PSD D50 (μm) ratio | (m²/g) |
| 14.5 wt % | 3.51 | 42.69 | 0.008912 | 25.92 |
| PAN (C) | | | | |

### Example 5 (b) Electrode Composition

An anode composition consisting of carbon coated micro-silicon was fabricated. The specific electrode composition used for all experiments is shown in Table 13 below.

TABLE 13
Electrode composition

| | | Content | |
|---|---|---|---|
| Materials | Description | [wt %] | Mass (g) |
| Active material | Silicon (coated with | 82.20 | 37.4 |
| | 14.5 wt % PAN (C)) | | |
| Conductive filler | Timrex KS6L flaked graphite | 7.80 | 2.73 |
| Conductive aid | Timcal Super C65 | 2.00 | 0.91 |
| Binder | PAA, 25% neutralized | 8.00 | 18.2 |
| | with LiOH | | |
| Water | — | — | 19.76 |

### Example 5 (c) Slurry Preparation

Material quantities specified in Table 13 were used for the slurry preparation process. The same procedure as in Example 1 was followed.

### Example 5 (d) Electrochemical Test Program

The full cells were assembled using the procedure described in Example 1. Please see Table 1 and 2 for the cycling program.

### Example 5 (e) Cycling Test—Summary of Key Findings

TABLE 14
Overview of limited capacity full cell electrochemical data

| | | | | | | Cathode | | Anode | |
|---|---|---|---|---|---|---|---|---|---|
| | Anode | | | | | Discharge | Discharge | Discharge | Discharge |
| | | Specific | Areal capacity | | | Capacity | Capacity | Capacity | Capacity |
| Coated | Thickness | loading | Anode | Cathode | ICE | @C/20 | @C/2 | @C/20 | @C/2 |
| material | μm | mg/cm² | mAh/cm² | mAh/cm² | % | mAh/g | mAh/g | mAh/g | mAh/g |
| Uncoated | 53 | 5.9 | 12.8 | 4.2 | 89.0 | 160 | 132 | 714 | 588 |
| 14.5 wt % | 50.8 | 5.7 | 12.2 | 3.5 | 82.1 | 148 | 120 | 696 | 562 |
| PAN (C) | | | | | | | | | |

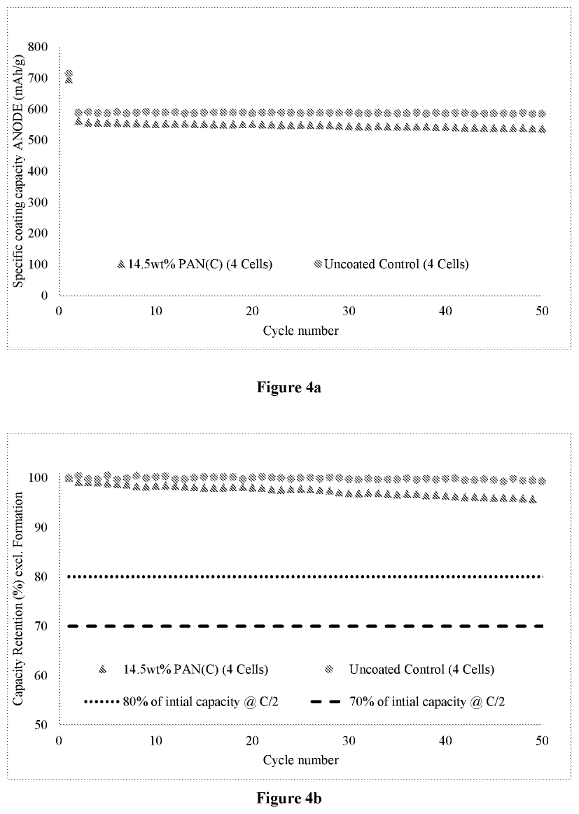

14.5 wt % PAN coated micro-Si had 82.1% ICE whereas the uncoated mSi had 89% ICE (Table 14). After 50 cycles (FIG. 4b) the PAN coated sample lost 4.4% of its capacity.

### Example 6: Pre-Lithiation of Coated Micro-Silicon

### Example 6 (a) Electrode Composition

All silicon material samples were incorporated into electrodes using the specific electrode composition shown in Table 15 below.

TABLE 15
Electrode composition

| | | | Conductive filler | | | | Binder (PAA, | | |
|---|---|---|---|---|---|---|---|---|---|
| | Active | | (Timrex KS6L | | Conductive aid | | 25% neutralized | | |
| | material (Si) | | flaked graphite) | | (Timcal Super C65) | | with LiOH) | | H₂O |
| Example | wt % | Mass (g) | wt % | Mass (g) | wt % | Mass (g) | wt % | Mass (g) | Mass (g) |
| 0.6 wt % | 70.40 | 32.03 | 19.60 | 8.92 | 2 | 0.91 | 8 | 18.20 | 21.26 |
| Al₂O₃ | | | | | | | | | |
| 3.12 wt % | 75.30 | 34.26 | 14.70 | 6.69 | 2 | 0.91 | 8 | 18.20 | 19.76 |
| PVP (C) | | | | | | | | | |

### Example 6 (b) Slurry Preparation

Material quantities specified in Table 15 were used for the slurry preparation process. The same procedure as in Example 1 was followed.

### Example 6 (c) Electrochemical Test Program

TABLE 16
Formation test-program of half cell (to prelithiate)

| | | Cut-off | |
|---|---|---|---|
| Name | Rate | (V) | Notes |
| Rest | | | 12 h |
| Constant | C/20 | 0.01 | Capacity cut-off (degree |
| current discharge | | | of prelithiation %*anode |
| | | | expected capacity mAh |
| End Cycle | | | |

### Example 6 (d) Prelithiation Step

The slurries were cast onto copper foil and dried at 60° C. then cut for coin cell assembly. The electrodes were further dried under vacuum for 12 h at 110° C. Lithium (Li) metal was used as the counter electrode and Celgard separator was used. 150 μL 1M LiPF₆ in FEC/DEC (2:8) vol. % was used as electrolyte for the coin cell assembly. The coin cells went through partial formation cycle at 0.05 C up to a certain degree of lithiation based on the anodes expected capacity (Table 16).

The C rates were based on the mass of active material (Si particles, graphite) in the electrodes. First lithiation is limited by capacity (mAh/g) to a 20% of the anode expected capacity accounting for a ˜10% lithium loss on first cycle.

### Example 6 (e) Post-Prelithiation Step

Coin cells were taken down and introduced to the glove box (under Ar atmosphere) and disassembled for full cell preparation. Anodes were washed with DMC and dried prior to assembly. The full cells were assembled using the procedure described in Example 1. Please see Table 1 and 2 for the cycling program

### Example 6 (f) Cycling Test—Summary of Key Findings

TABLE 17
Overview of limited capacity full cell electrochemical data

| | | | | | | | Cathode | | Anode | |
|---|---|---|---|---|---|---|---|---|---|---|
| | | Anode | | | | | Discharge | Discharge | Discharge | Discharge |
| | Pre- | | Specific | Areal capacity | | | Capacity | Capacity | Capacity | Capacity |
| Coated | lithiation | Thickness | loading | Anode | Cathode | ICE | @C/20 | @C/2 | @C/20 | @C/2 |
| material | % | μm | mg/cm² | mAh/cm² | mAh/cm² | % | mAh/g | mAh/g | mAh/g | mAh/g |
| 0.6 wt % | 10 | 54.0 | 5.9 | 12.6 | 3.5 | 90.5 | 162 | 144 | 743 | 660 |
| Al2O3 | | | | | | | | | | |
| 0.6 wt % | 0 | 55.5 | 5.7 | 12.4 | 3.5 | 89.8 | 162 | 132 | 763 | 622 |
| Al2O3 | | | | | | | | | | |
| 3.12 wt % | 10 | 54.0 | 5.9 | 12.6 | 3.5 | 90.4 | 162 | 143 | 734 | 650 |
| PVP (C) | | | | | | | | | | |
| 3.12 wt % | 0 | 52.9 | 5.7 | 12.2 | 3.5 | 88.4 | 160 | 128 | 751 | 602.0 |
| PVP (C) | | | | | | | | | | |

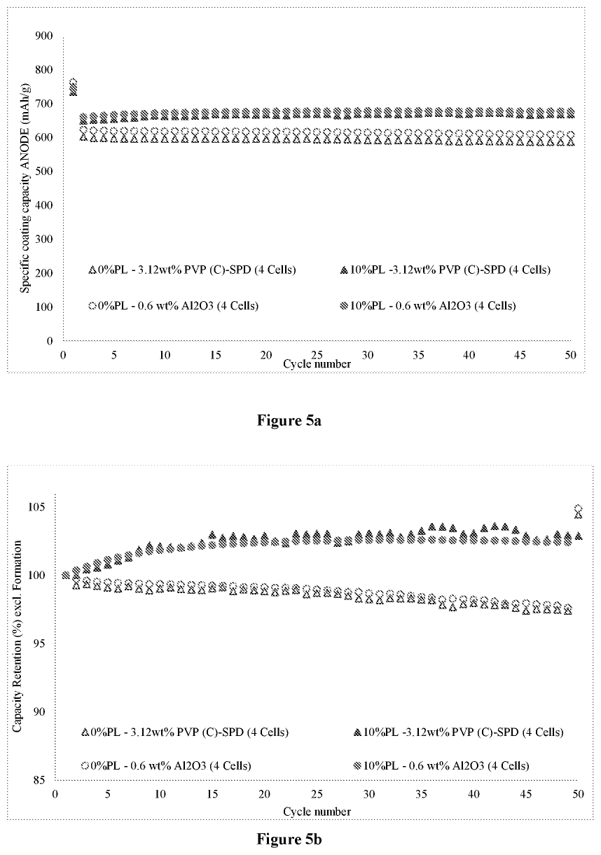

The data for the unlithiated samples were taken from example 2 for 0.6 wt % Al₂O₃ and example 4 for 3.12 wt % PVP. The electrochemical prelithiation of the coated samples has significantly improved the ICE (˜1%) when compared to unlithiated which led to cycling at a higher capacity (Table 17). Cycling capacity and average coulombic efficiency increased substantially. Negligible capacity loss was observed over the initial 50 cycles for both prelithiated (3.12 wt % PVP cells and 0.6 wt % Al₂O₃) cells (FIG. 5).

1. An anode composition comprising micro silicon active material particles,
wherein the micro silicon active material particles have one or more of the following: (i) a measured BET surface area between about 0.1 m²/g and about 10 m²/g, (ii) a D₅₀ particle size between about 0.1 μm and about 10 μm, and (iii) a ratio of D₅₀:BET surface area between about 0.1 to about 10,
wherein the amount of the micro silicon active material particles present in the anode composition is between about 60 wt. % and about 95 wt. % based on the total weight % of the anode composition, and
wherein the anode composition comprises a coating.

2. The anode composition of claim 1, wherein the coating is a coating of the micro silicon active material particles.

3. The anode composition of claim 1, wherein the coating is a coating of the anode composition.

4. The anode composition of, wherein the ratio of D₅₀:BET surface area of the micro silicon active material particles is between about 0.1 to about 6.

5. The anode composition of, wherein the coating is selected from the group comprising carbon, graphene, graphite, metal oxide, polymer, and combinations thereof, to form a coated micro silicon active material particle.

6. The anode composition of, wherein the measured BET surface area of the micro silicon active material particles is between about 1 m²/g and about 5 m²/g.

7. (canceled)

8. (canceled)

9. The anode composition of, wherein the purity of the micro silicon active material particles is at least 95 wt. % (without oxygen).

10. The anode composition of, wherein the D₅₀ particle size of the micro silicon active material particles is between about 2 μm and about 8 μm.

11. (canceled)

12. The anode composition of, wherein the thickness of the coating is between about 0.1 nm and about 200 nm.

13. The anode composition of, wherein the ratio of the coating thickness to uncoated silicon particle diameter (t/d as X: 1) is between about 0.0001:1 to about 0.2:1.

14. The anode composition of, wherein the anode composition further comprises one or more binders.

15-17. (canceled)

18. The anode composition of, wherein the micro silicon active material particles or coated micro silicon active material particles are prelithiated.

19-25. (canceled)

26. The anode composition of, wherein the anode composition is an anode for a primary battery or a secondary battery.

27. (canceled)

28. An electrochemical cell comprising: an anode; a cathode; an electrolyte; and a separator,
wherein the anode comprises the anode composition of,
wherein the lithium uptake capacity of the anode is greater than the lithium release capacity of the cathode.

29. The electrochemical cell of claim 28, wherein the capacity of the lithium uptake capacity of the anode is not fully utilized during charging of the lithium ion battery.

30. The electrochemical cell of claim 28, wherein the anode is only partially lithiated in the fully charged state.

31. (canceled)

32. The cell of, wherein a capacity ratio (N/P ratio) of the anode and the cathode is between about 1.05 and about 7.

33. (canceled)

34. (canceled)

35. The electrochemical cell of, wherein the lower cut-off voltage is between about 2.5V and 3.0V.

36-40. (canceled)

41. The electrochemical cell of, wherein the is a battery, preferably a secondary battery.

42. (canceled)

43. A method for improving cycling stability of a lithium-ion battery having an anode and a cathode, at least one electrolyte, and optionally a separator, wherein the anode composition is defined.

44-59. (canceled)
